(19) United States
(12) Patent Application Publication
(10) Pub. No.: US 2026/0022273 A1
(43) Pub. Date: Jan. 22, 2026

(54) PRESSURE-SENSITIVE ADHESIVE TAPE, ARTICLE, AND METHOD FOR DISMANTLING ARTICLE

(71) Applicant: DIC Corporation, Tokyo (JP)

(72) Inventors: Junko Kanda, Saitama (JP); Takahiro Obi, Saitama (JP); Yusuke Takahashi, Saitama (JP)

(73) Assignee: DIC Corporation, Tokyo (JP)

(21) Appl. No.: 19/262,435

(22) Filed: Jul. 8, 2025

(30) Foreign Application Priority Data
Jul. 18, 2024 (JP) 2024-114815

(51) Int. Cl. C09J 7/29; C09J 133/06

(52) U.S. Cl. CPC C09J 7/29; C09J 133/064; C09J 2203/37; C09J 2301/124; C09J 2301/16; C09J 2301/302; C09J 2301/314; C09J 2301/41; C09J 2301/502; C09J 2400/16; C09J 2433/00; C09J 2453/00

(57) ABSTRACT

[Object] To provide a pressure-sensitive adhesive tape that can be thermally detached within a short period of time and can prevent thermal damage to the adherend, and allows for easy thermal detachment procedures; an article in which at least two adherends are bonded via the pressure-sensitive adhesive tape; and a method for dismantling the article.

[Solution] A pressure-sensitive adhesive tape including a pressure-sensitive adhesive layer, a heating element, and a melt-softening layer that is adjacent to the heating element at least in this order, in which the heating element has an average thickness of 2 μm or more and 200 μm or less and is a heating element formed of an electrically conductive filler bound into a sheet.

### TECHNICAL FIELD

The present invention relates to a pressure-sensitive adhesive tape, an article, and a method for dismantling an article. In detail, the invention relates to a pressure-sensitive adhesive tape that is applicable to various fields such as the production of electronic devices, for example; an article having a configuration in which bonding is achieved via the pressure-sensitive adhesive tape; and a method for dismantling the article.

### BACKGROUND ART

Pressure-sensitive adhesive tapes have been used as joining means with excellent workability and high adhesion reliability in various industrial fields including the fields of office automation equipment, IT products, home appliances, automobiles, and the like, and applied for fixing components, for temporarily fixing components, and as labels that display product information, for example. In recent years, from the viewpoint of global environmental protection, in these home appliance, automotive, and like various industrial fields, there has been an increasing need for recycling and reusing used products.

When recycling and reusing various products, an operation to detach a pressure-sensitive adhesive tape used to fix components or as a label is required, and, because pressure-sensitive adhesive tapes are placed in various locations within a product, there is a demand for a simplified removal process to reduce operational costs.

In order to separate adherends from each other, for example, a hot-melt adhesive composition that melts quickly within a short period of time upon electromagnetic induction heating has been proposed (see, e.g., PTL 1).

As a method for separating adherends from each other, a method for dismantling a building, in which a base material made of metal is heated with an electromagnetic induction heating apparatus to induce the thermal foaming of the adhesive between this base material and an interior material, causing detachment, and the interior material is peeled off from the base material made of metal, has been proposed (see, e.g., PTL 2).

In addition, a double-sided adhesive tape having a thermally conductive layer, which can be easily dismantled by directly heating the thermally conductive layer through contact with a heat generation source, has been proposed (see, e.g., PTL 3).

### CITATION LIST

### Patent Literature

[PTL 1] JP2002-188068A
[PTL 2] JP2006-200279A
[PTL 3] JP2016-108394A

### SUMMARY OF INVENTION

### Technical Problem

However, in the conventional methods of detachment and dismantling through heating, because heat is applied from the outside, when an attempt is made to cause a heating element to generate the amount of heat required to detach the pressure-sensitive adhesive tape, it may happen that the generated heat causes thermal deterioration or thermal damage to the adherend. Meanwhile, when an attempt is made to suppress thermal deterioration or thermal damage to the adherend, it may happen that the amount of heat generation decreases, and the pressure-sensitive adhesive tape is not sufficiently heated, making detachment unlikely to occur.

Therefore, as a pressure-sensitive adhesive tape for fixing adherends such as rigid bodies together, a pressure-sensitive adhesive tape having a function that allows components, which are adherends, to be dismantled and reused is demanded, and a pressure-sensitive adhesive tape having a function that allows for easy dismantling and detachment through heating is especially required.

An object of the invention is to provide a pressure-sensitive adhesive tape that can be thermally detached within a short period of time, can prevent thermal damage to the adherend, and allows for easy thermal detachment procedures; an article having a configuration in which bonding is achieved via the pressure-sensitive adhesive tape; and a method for dismantling the article.

### Solution to Problem

The invention relates to the following (1) to (14).

(1) A pressure-sensitive adhesive tape including a pressure-sensitive adhesive layer, a heating element, and a melt-softening layer that is adjacent to the heating element at least in this order, in which the heating element has an average thickness of 2 μm or more and 200 μm or less and is a heating element formed of an electrically conductive filler bound into a sheet. (2) The pressure-sensitive adhesive tape according to (1), in which the heating element has a volume resistivity at 20° C. of 50 μΩ·cm or more. (3) The pressure-sensitive adhesive tape according to (1) or (2), in which the heating element is a heating element formed of a fibrous or particulate electrically conductive filler bound into a sheet and further impregnated with a binder. (4) The pressure-sensitive adhesive tape according to any of (1) to (3), in which the heating element is a heating element formed of a fibrous or particulate electrically conductive filler and an organic substance filler bound into a sheet. (5) The pressure-sensitive adhesive tape according to any of (1) to (4), in which the heating element is a heating element formed of a fibrous or particulate electrically conductive filler sintered into a sheet. (6) The pressure-sensitive adhesive tape according to any of (1) to (5), in which the electrically conductive filler is selected from the group consisting of a metal, an alloy, and carbon. (7) The pressure-sensitive adhesive tape according to any of (1) to (6), in which the heating element has, in a plan view, a pair of projecting portions projecting from the outer periphery of the pressure-sensitive adhesive layer and the melt-softening layer. (8) The pressure-sensitive adhesive tape according to any of (1) to (7), further including a pressure-sensitive adhesive layer on the other surface side of the melt-softening layer from the surface adjacent to the heating element. (9) The pressure-sensitive adhesive tape according to any of (1) to (8), in which the melt-softening layer becomes detachable upon heating. (10) The pressure-sensitive adhesive tape according to any of (1) to (9), in which the heating element is a current-carrying body that generates heat upon the passage of a current, and the heat generation of the current-carrying body causes detachment. (11) An article including at least two adherends and the pressure-sensitive adhesive tape according to any of (1) to (10) between the two adherends, in which the two adherends are bonded via the pressure-sensitive adhesive tape. (12) The article according to (11), in which the heating element constituting the pressure-sensitive adhesive tape has, in a plan view, a pair of projecting portions projecting from the outer periphery of the adherends. (13) A method for dismantling an article, being a method for dismantling the article according to (11) or (12), the method including heating the heating element to melt and/or soften the melt-softening layer, thereby separating the two adherends. (14) The method for dismantling an article according to (13), in which the heating of the heating element is resistance heating, and the method includes electrically connecting the heating element to a power supply, passing a current through the heating element from the power supply, and causing resistance heating to melt and/or soften the melt-softening layer, thereby separating the two adherends.

### Advantageous Effects of Invention

According to the invention, a pressure-sensitive adhesive tape that can be thermally detached within a short period of time and can prevent thermal damage to the adherend, and allows for easy thermal detachment procedures, can be provided.

In addition, according to the invention, an article in which at least two adherends are bonded via the pressure-sensitive adhesive tape, as well as a method for dismantling the article, can be provided, and the thermal degradation of adherends such as electronic components is suppressed, allowing them to be reused, and the dismantling operations are facilitated.

### BRIEF DESCRIPTION OF DRAWINGS

FIG. 1 A schematic cross-sectional view showing an example of the pressure-sensitive adhesive tape of the invention.

FIG. 2 A schematic cross-sectional view showing another example of the pressure-sensitive adhesive tape of the invention.

FIG. 3 A schematic plan view showing another example of the pressure-sensitive adhesive tape of the invention.

FIG. 4 Schematic plan views showing examples of the pattern of a heating element in the pressure-sensitive adhesive tape of the invention.

FIG. 5 A schematic cross-sectional view showing another example of the pressure-sensitive adhesive tape of the invention.

FIG. 6 A schematic plan view showing an example of the article of the invention.

FIG. 7 A schematic cross-sectional view showing an example of the article of the invention.

FIG. 8 A diagram schematically showing the method for dismantling an article of the invention.

FIG. 9 A schematic plan view of the pressure-sensitive adhesive tape of Example 1.

FIG. 10 A schematic cross-sectional view of the pressure-sensitive adhesive tape of Example 1.

FIG. 11 A schematic plan view showing an article of an example and an evaluation method.

FIG. 12 A schematic front view showing an article of an example and an evaluation method.

FIG. 13 A schematic side view showing an article of an example and an evaluation method.

### DESCRIPTION OF EMBODIMENTS

Hereinafter, embodiments of the invention will be described in detail. Incidentally, as used herein, a numerical range indicated using “to” represents a range including the numerical values before and after “to” as the minimum and the maximum, respectively.

### 1. Pressure-Sensitive Adhesive Tape

The invention is a pressure-sensitive adhesive tape including a pressure-sensitive adhesive layer, a heating element, and a melt-softening layer that is adjacent to the heating element at least in this order, in which the heating element has an average thickness of 2 μm or more and 200 μm or less and is a heating element formed of an electrically conductive filler bound into a sheet.

The pressure-sensitive adhesive tape of the invention can be used as an easy-to-dismantle pressure-sensitive adhesive tape, which is configured such that after a certain period of time has elapsed after its attachment to adherends to fix the adherends together, the fixation between the adherends can be easily separated or dismantled.

Because of the above configuration, without limitation by the material of the adherends, the pressure-sensitive adhesive tape of the invention maintains high adhesion force when fixing the adherends together, while allows for easy separation or dismantling through heating when the adherends are to be separated or dismantled. Incidentally, “separation or dismantling” will also be simply referred to as “dismantling” hereinafter.

The pressure-sensitive adhesive tape of the invention has a heating element. Heat generation is caused by directly passing a current through the heating element, or by a heating means using energy irradiation from the outside, such as induction heating, infrared heating, or microwave heating, thereby melting or softening the melt-softening layer adjacent to the heating element.

In the invention, for the reason that the deterioration of the adherends due to energy irradiation from the outside can be suppressed, and the article can be dismantled while the pressure-sensitive adhesive tape is in a built-in state in the article, it is preferable that the heating element is a current-carrying body that generates heat upon the passage of a current. According to a preferred mode, the pressure-sensitive adhesive tape of the invention is detached upon the heat generation of the current-carrying body.

Here, because the heating element has an average thickness of 2 μm or more and 200 μm or less and is a heating element formed of an electrically conductive filler bound into a sheet, the pressure-sensitive adhesive tape of the invention can be provided with an increased volume resistance value. In detail, as a result of designing the heating element to have a small average thickness, a tendency toward higher volume resistivity can be provided.

That is, this produces an action that enhances the amount of heat generation in the heating element with the application of a smaller current. Due to this action, the thermoplastic resin constituting the melt-softening layer can be efficiently melted or softened.

Accordingly, the pressure-sensitive adhesive tape of the invention has sufficient initial adhesion force near room temperature (0 to 40° C.), and, at the same time, the adhesive strength decreases with heating by heat from the heating element. Thus, the residual adhesion force after current passage relative to the initial adhesion force is low, and the reduction rate of adhesion force due to current passage is high. Therefore, an article made using the pressure-sensitive adhesive tape of the invention has excellent dismantlability.

In addition, the pressure-sensitive adhesive tape of the invention can offer a sufficient amount of heat generation with a low current that does not physically affect the worker even in the case where the worker accidentally comes into contact with live parts during the dismantling operations. Therefore, the dismantling method of the invention is excellent in work safety.

In other words, in the pressure-sensitive adhesive tape of the invention, heat generation is caused inside the tape. Therefore, when an article in which at least two adherends are bonded via the pressure-sensitive adhesive tape of the invention is dismantled, the article can be easily dismantled while reducing thermal damage to the adherends.

In addition, also in the case of an article in which electronic components are bonded, which is built into a device and completely shielded from the outside with no access to the pressure-sensitive adhesive tape, the electronic components can be easily dismantled from each other without the preparation of a large-scale apparatus. In particular, in the case where the drive current in the electronic components is used to thermally dismantle the pressure-sensitive adhesive tape in a built-in state in the electronic device, thermal deterioration of the circuits in the electronic components, etc., can be prevented, and, at the same time, thermal detachment is possible without the need for external apparatuses, etc., facilitating the dismantling operations.

The mode in which the pressure-sensitive adhesive tape of the invention “becomes detachable upon heating” may be a mode in which the inside of the pressure-sensitive adhesive tape, particularly the melt-softening layer itself, melts or softens upon heating, causing cohesive failure inside the melt-softening layer, and the pressure-sensitive adhesive tape is partially or completely detached from the adherend, or may also be a mode in which the inside of the pressure-sensitive adhesive tape, particularly the melt-softening layer itself, melts or softens upon heating, leading to the reduction of its adhesion force, causing detachment (interfacial failure) between the melt-softening layer and the layer adjacent to the melt-softening layer or the adherend, and the pressure-sensitive adhesive tape thus becomes partially or completely detachable from the adherend.

In addition, at the time of the detachment of the pressure-sensitive adhesive tape through heating, the melt-softening layer may be integrally detached from the adherend, or a portion of the melt-softening layer may be detached from the adherend.

In addition, the pressure-sensitive adhesive layer constituting the pressure-sensitive adhesive tape of the invention is composed of, as described later, a component that is less likely to melt or soften upon heating than the components constituting the melt-softening layer.

Therefore, in the pressure-sensitive adhesive tape of the invention, as a result of causing the heating element to generate heat, the melt-softening layer is heated and selectively melted or softened, allowing for detachment.

Hereinafter, the configuration of the pressure-sensitive adhesive tape of the invention will be described.

### [Heating Element]

The heating element in the pressure-sensitive adhesive tape of the invention has an average thickness of 2 μm or more and 200 μm or less and is a heating element formed of an electrically conductive filler bound into a sheet.

In the heating element in the pressure-sensitive adhesive tape of the invention, the rise in the temperature of the heating element upon the application of a current of 0.5 A to the heating element for 30 seconds is preferably 120° C. or more, and more preferably 150° C. or more.

When the pressure-sensitive adhesive tape of the invention has a heating element having such characteristics in its configuration, when an article in which at least two adherends are bonded via the pressure-sensitive adhesive tape of the invention is dismantled, the article can be easily dismantled while reducing thermal damage to the adherends.

As the electrically conductive filler, a filler selected from the group consisting of a metal, an alloy, and carbon is preferable. As metals, silver, iron, copper, aluminum, nickel, titanium, chromium, platinum, gold, palladium, rhodium, iridium, ruthenium, and the like can be mentioned.

As alloys, for example, alloys of two or, three or more metals, such as stainless steel (SUS410, SUS304, SUS430, etc.); brass, cupronickel, bronze, nichrome, and nickel silver, can be mentioned. As carbon, for example, carbon in the form of carbon nanomaterials, etc., such as graphite, graphene, graphene oxide, carbon nanotubes, graphene platelets, and carbon nanofibers, and the like can be mentioned.

A single kind of electrically conductive filler may be used alone, and it is also possible to use two or more kinds together.

Among them, the electrically conductive filler is more preferably a filler selected from the group consisting of silver, stainless steel, and carbon.

The electrically conductive filler is preferably fibrous or particulate.

In the case where the electrically conductive filler is fibrous, from the viewpoint that the below-described fibrous electrically conductive filler in the form of a nonwoven fabric can be easily obtained, the average fiber diameter is preferably within a range of 0.01 μm to 30 μm, and more preferably within a range of 0.02 μm to 20 μm.

The cross-sectional shape perpendicular to the fiber longitudinal direction may be circular, elliptical, approximately rectangular, irregular, or the like. As used herein, “average fiber diameter” refers to the average area diameter derived by, with respect to 20 fibers of the fibrous electrically conductive fillers photographed under a microscope, calculating the cross-sectional area at any cross-section perpendicular to the longitudinal direction and calculating the diameter of a circle having the same area as the cross-sectional area.

In the case where the electrically conductive filler is fibrous, from the viewpoint that the homogeneity of the below-described fibrous electrically conductive filler in the form of a nonwoven fabric can be easily enhanced, the average fiber length is preferably within a range of 0.01 mm to 10 mm, and more preferably within a range of 0.03 mm to 5 mm. As used herein, “average fiber length” is the average value obtained by measuring 20 fibers of the fibrous electrically conductive fillers photographed under a microscope.

In the case where the electrically conductive filler is fibrous, the aspect ratio is preferably 33 to 10,000, and more preferably 150 to 1,500.

In the case where the electrically conductive filler is particulate, the shape of particles is not particularly limited, and may be spherical, flaky, layered, leaf-like, columnar, equiaxed, foliated, tabular, wedge-like, rosette-like, or the like.

In the case where the electrically conductive filler is particulate, from the viewpoint that the strength of the heating element in a bound state can be easily maintained, and the volume resistivity of the heating element can be easily controlled, the particle size (average particle size) is preferably within a range of 0.01 μm to 500 μm, more preferably within a range of 0.02 μm to 200 μm, and still more preferably within a range of 0.05 μm to 100 μm. Incidentally, the particle size of a particulate electrically conductive filler is the median diameter (D50) value measured with a laser diffraction/scattering particle size distribution analyzer.

As methods for binding an electrically conductive filler, sintering, chemical etching, laser welding, induction heating, chemical bonding, thermal bonding, and the like can be mentioned.

In the case where, like a silver nano-ink, the electrically conductive filler is in a mode where silver nanoparticles or silver nanowires are dispersed in a dispersion medium, for example, such an ink can be applied to a substrate, dried, and then subjected to the above binding method, thereby forming a sheet-shaped electrically conductive filler, that is, a heating element.

Here, when an electrically conductive filler is bound, this refers to a state in which the electrically conductive filler is physically fixed, and the portion where the electrically conductive filler is physically fixed is referred to as a binding site.

At a binding site, electrically conductive filler pieces may be directly fixed to each other, or it is also possible that some of the electrically conductive filler pieces are indirectly fixed to each other via a component other than metal components.

Among them, from the viewpoint that binding is likely to be ensured to achieve fixation between electrically conductive filler pieces, and the coefficient of variation (CV value) of the basis weight in the heating element as specified in JIS Z8101 (ISO3534), etc., is likely to be stabilized, sintering is preferable as the binding method.

That is, it is preferable that the heating element is a heating element formed of a fibrous or particulate electrically conductive filler sintered into a sheet, and it is preferable that a fibrous electrically conductive filler in the form of a nonwoven fabric is sintered.

Incidentally, as methods for making a fibrous electrically conductive filler into the form of a nonwoven fabric, a dry method in which a fibrous electrically conductive filler or a web composed mainly of a fibrous electrically conductive filler is compressed and molded by a carding method, an air-laid method, or the like; and a wet papermaking method in which a fibrous electrically conductive filler is dispersed in water to prepare a slurry, which is then formed into a sheet, followed by steps of dehydration, pressing, and drying, can be mentioned.

Sintering is preferably performed in a vacuum or a non-oxidizing atmosphere at a temperature equal to or lower than the melting point of the material constituting the electrically conductive filler (metal, alloy).

In addition, the heating element in the pressure-sensitive adhesive tape of the invention is more preferably a heating element formed of a fibrous or particulate electrically conductive filler bound into a sheet and further impregnated with a binder.

Such a heating element is preferable from the viewpoint that in this case, the interlayer adhesive strength between the pressure-sensitive adhesive layer and the heating element, and also between the melt-softening layer and the heating element, tends to increase, and the performance of the pressure-sensitive adhesive tape is likely to improve.

As such binders, organic binders such as epoxy resins, acrylonitrile-butadiene copolymer resins, unsaturated polyester resins, phenol resins, melamine resins, polyimide resins, polyurea resins, and polyurethane resins; and inorganic binders such as colloidal silica, water glass, and sodium silicate can be mentioned. Among them, acrylonitrile-butadiene copolymer resins and phenol resins are preferrable, and resol-type phenol resins are more preferrable.

As the heating element formed of a fibrous or particulate electrically conductive filler bound into a sheet and further impregnated with a binder, a carbon-based sheet may also be used.

As carbon-based sheets, for example, a graphite sheet using carbon fibers and graphite or like carbon particles as electrically conductive fillers, and also using the above resin, favorably a resol-based phenol resin, as a binder, etc., can be mentioned.

In addition, it is also preferable that the heating element in the pressure-sensitive adhesive tape of the invention is a heating element formed of the above fibrous or particulate electrically conductive filler and an organic substance filler bound into a sheet.

Such a heating element is preferable from the viewpoint that in this case, the volume resistivity of the heating element can be easily controlled within the below-described favorable range, also the strength of the heating element tends to increase, and the performance of the pressure-sensitive adhesive tape is likely to improve.

As such organic substance fillers, cellulose-based fillers derived from natural sources, such as wood pulp, rice husks, cotton, bamboo, kenaf, and hemp; liquid crystal polyester, aromatic polyamide, nylon, and like heat-resistant resin fillers, and the like can be mentioned. The organic substance filler may be fibrous or particulate, and the favorable ranges of its average fiber diameter, average fiber length, and average particle size are preferably the same as those of the electrically conductive filler described above.

In the case where the heating element is formed of a fibrous or particulate electrically conductive filler and an organic substance filler bound into a sheet, the content of the organic substance filler in the overall heating element is preferably within a range of 0.01 to 60 mass %, and more preferably within a range of 0.01 to 40 mass %.

As the heating of the heating element and heating means therefor, for example, resistance heating, electromagnetic induction heating, infrared heating, microwave heating, thermal conduction, and the like can be mentioned.

Among them, resistance heating is preferrable from the viewpoint that the melt-softening layer can be sufficiently softened or melted even with a small amount of energy, for example, the drive current in an electronic component can be used to thermally dismantle the pressure-sensitive adhesive tape in a built-in state in an electronic device, and also from the viewpoint that there is no need to use an external heat source to heat the heating element via the adherend, making it possible to prevent the excessive heating of the adherend.

Here, “resistance heating” is a type of electrical heating method, in which a current is allowed to flow through a current-carrying body having resistance (heating element), and the current-carrying body is heated by the resulting Joule heat. When a steady current is allowed to flow through a current-carrying body, the amount of Joule heat generated in a given period of time is proportional to the square of the magnitude of the current and the resistance of the conductor (Joule's law). The current-carrying body has a resistance value (volume resistivity, etc.) intrinsic to the substance.

“Electromagnetic induction heating” is a non-contact heating method, which is a type of electrical heating method, and is also referred to as high-frequency induction heating. When a high-frequency current (alternating current) is allowed to flow through a coiled conductor, and a current-carrying body having resistance (heating element) is placed in the resulting magnetic field, the current flows through the current-carrying body based on the principle of electromagnetic induction, and the current-carrying body is heated by the resulting Joule heat.

“Infrared heating” and “microwave heating” are non-contact heating methods that utilize radiation heat energy using electromagnetic waves in specific wavelength ranges, such as infrared rays and microwaves.

The atomic bonds and molecules that constitute a substance thermally vibrate corresponding to the temperature of the substance itself (molecular motion and crystal lattice vibrations), and when electromagnetic waves with a wavelength corresponding to this vibration frequency are absorbed, the molecular vibrations intensify, leading to heat generation.

“Thermal conduction” is a heating method that utilizes the heat transfer phenomenon in which heat is transferred from a high temperature side to a low temperature side inside a solid. Heat can be transferred by bringing the heat generation source into direct contact with a substance having excellent thermal conductivity.

In the case where the heating means is resistance heating, the volume resistivity of the heating element at 20° C. is preferably 50 μΩ·cm or more, more preferably 70 μΩ·cm or more, and still more preferably 100 μΩ·cm or more. From the viewpoint of preventing the voltage required for current passage through the heating element from being too high, the volume resistivity of the heating element at 20° C. is preferably 100,000 μΩ·cm or less, more preferably 20,000 μΩ·cm or less, still more preferably 10,000 μΩ·cm or less, and particularly preferably 5,000 μΩ·cm or less. Specifically, the volume resistivity of the heating element can be within a range of 50 to 100,000 μΩ·cm, within a range of 50 to 20,000 μΩ·cm, within a range of 70 to 10,000 μΩ·cm, or within a range of 100 to 5,000 μΩ·cm.

When the volume resistivity of the heating element is 50 μΩ·cm or more, at the time of dismantling an article, in the case of making a connection to the wiring circuit in an electronic device and passing the drive current of the electronic device through the heating element, for example, only the pressure-sensitive adhesive tape can be heated, making it possible to prevent the high-temperature deterioration of the wiring circuit.

In addition, when a heating element having a volume resistivity within the above range is used, the melt-softening layer can be melted or softened within a short period of time, and the dismantling time can be shortened.

Further, at the time of using the drive current in an electronic component, the electronic circuit and connections can be prevented from being excessively heated due to current passage through the heating element, making it possible to prevent the thermal deterioration of the electronic component.

The volume resistivity of the heating element can be measured at 20° C. in accordance with JIS K 7194 using a low resistivity meter (trade name “Loresta-AX MCT-T370” manufactured by Nittoseiko Analytech Co., Ltd.) and a four-point probe (trade name “ASP Probe MCP-TP03P” manufactured by Nittoseiko Analytech Co., Ltd.). The number of measurement points is set to a one-point measurement, and a resistivity correction factor of 4.532 is used.

The heating element formed of an electrically conductive filler bound into a sheet may have a mesh shape, but usually has a planar shape. In the case of a planar heating element, the heating element can be sufficiently bonded to the melt-softening layer in contact therewith before current passage, while at the time of current passage, because heat is generated on the plane, it is unlikely to happen that the heating element itself is destroyed, or disconnection occurs, at the time of current passage and dismantling.

As a planar heating element, a heating element formed of the above fibrous or particulate electrically conductive filler, preferably an electrically conductive filler in the form of a nonwoven fibrous, bound by sintering into a sheet is preferable, and a heating element formed of a fibrous or particulate electrically conductive filler bound into a sheet and further impregnated with a binder is more preferable.

The planar heating element may be formed in a pattern, or may also be in a band form or a wire form (see also the below-described FIG. 4). A heating element in a band form or a wire form is advantageous in that the heat generation efficiency is high, the contact area with the adherend is small, and thus detachment is easy. In this case, the length of the heating element in the minor axis direction (band width or wire width) is preferably from 0.5 to 20 mm, more preferably from 1 to 10 mm, and still more preferably from 2 to 5 mm.

When the planar heating element is in a pattern form (has a pattern shape), the distance between the terminals of the heating element (terminals for connection to the power supply) can be longer, and the resistance can be increased.

Therefore, the heat generation efficiency of the planar heating element increases, allowing the pressure-sensitive adhesive tape of the invention to be detached within a short period of time. In the case where the planar heating element is in a pattern form, the pattern width is not particularly limited and can be the same as the preferred band width range described above.

The planar heating element may be in a mode where the heating element is disposed on one or both surfaces of the substrate. In this case, the heating element is disposed to be in direct contact with one or both surfaces of the substrate. In addition, the heating element may also be disposed to cover the entire area of one or both surfaces of the substrate, or may also be disposed in a wire form, a band form, or a pattern form.

The substrate is not particularly limited as long as it can support the heating element. From the viewpoint of the conformability, thickness reduction, heat resistance, and the like of the pressure-sensitive adhesive tape, films of polyesters such as polyethylene terephthalate and polyethylene naphthalate, polyolefins such as polypropylene, polyimide, and like resins are preferrable.

The average thickness of the heating element is 2 μm to 200 μm, preferably 5 μm or more, and more preferably 10 μm or more. Meanwhile, the average thickness of the heating element is preferably 200 μm or less, and more preferably 150 μm or less. From the viewpoint that the volume resistance value of the heating element can be easily enhanced, and a sufficient amount of heat generation is likely to be achieved in the pressure-sensitive adhesive tape of the invention even with a low current, the average thickness of the heating element is preferably within a range of 10 to 150 μm.

When the average thickness of the planar heating element is within the above range, a sufficient amount of current and heat generation can be obtained, and the heating element can be efficiently heated by resistance heating, providing the pressure-sensitive adhesive tape with excellent conformability and attachment workability.

Incidentally, the average thickness of a planar heating element is the average value obtained by measuring the thickness at five or more arbitrarily selected points. In the case where the planar heating element is in a mode where the heating element is disposed on one or both surfaces of the substrate, the average thickness of the planar heating element refers to the thickness excluding the substrate, while in the case where the heating element is disposed on each side of the substrate, the average thickness refers to the thickness of the heating element on each side.

The heating element formed of an electrically conductive filler bound by sintering into a sheet, or the heating element formed of a fibrous or particulate electrically conductive filler bound into a sheet and further impregnated with a binder, used may also be a commercially available product. For example, “Stainless Steel Fiber Sheet” from Tomoegawa Paper Co., Ltd., and “PGS Graphite Sheet” manufactured by Panasonic Corporation can be mentioned. In addition, they may also be pattern-molded and used.

### [Pressure-Sensitive Adhesive Layer]

In the pressure-sensitive adhesive tape of the invention, as components constituting the pressure-sensitive adhesive layer, for example, acrylic-based tackiness agents, urethane-based tackiness agents, synthetic rubber-based, natural rubber-based, and like rubber-based tackiness agents, silicone-based tackiness agents, vinyl ether-based tackiness agents, and the like can be mentioned. Among them, tackiness agents applicable as pressure-sensitive adhesives are preferrable, and acrylic-based tackiness agents containing an acrylic-based polymer are more preferrable. An acrylic-based tackiness agent containing an acrylic-based polymer is less likely to melt or soften upon heating.

Therefore, the below-described melt-softening layer that the pressure-sensitive adhesive tape of the invention has can be selectively melted or softened by the heat generated from the heating element of the pressure-sensitive adhesive tape of the invention. Incidentally, a pressure-sensitive adhesive is an adhesive that bonds upon the application of pressure for a short period of time at room temperature around 20° C., and has tackiness at room temperature.

As acrylic-based polymers, acrylic-based polymers such as homopolymers of (meth)acrylic acid ester monomers and copolymers of (meth)acrylic acid ester monomers and other monomers can be mentioned. As used herein, the term “(meth)acrylic” collectively refers to acrylic, methacrylic, and both. The term “(meth)acrylate” collectively refers to acrylate, methacrylate, and both.

As (meth)acrylic acid ester monomers, for example, (meth)acrylic acid alkyl esters having an alkyl chain having 1 to 14 carbon atoms, such as methyl (meth)acrylate, ethyl (meth)acrylate, propyl (meth)acrylate, butyl (meth)acrylate, hexyl (meth)acrylate, cyclohexyl (meth)acrylate, octyl (meth)acrylate, 2-ethylhexyl (meth)acrylate, isononyl (meth)acrylate, isodecyl (meth)acrylate, and lauryl (meth)acrylate can be mentioned.

The acrylic-based polymer may contain a single kind of such monomer in the structural unit, or may also contain two or more kinds of them in the structural unit.

The content of the (meth)acrylic acid ester monomer is preferably within a range of 70 to 99.9 mass %, more preferably within a range of 80 to 99 mass %, and still more preferably within a range of 90 to 97 mass %, relative to the total monomer components constituting the acrylic-based polymer.

In addition, as other monomers for obtaining an acrylic-based polymer, a polar group-containing monomer may also be contained. As polar group-containing monomers, for example, carboxylic acids having an ethylenically unsaturated group, such as (meth)acrylic acid, itaconic acid, itaconic anhydride, maleic acid, maleic anhydride, and crotonic acid; (meth)acrylates having a hydroxyl group, such as 2-hydroxyethyl (meth)acrylate, hydroxypropyl (meth)acrylate, 4-hydroxybutyl (meth)acrylate, caprolactone-modified (meth)acrylate, polyoxyethylene (meth)acrylate, and polyoxypropylene (meth)acrylate; and nitrogen-containing monomers having an ethylenically unsaturated group, such as (meth)acrylonitrile, N-vinyl-2-pyrrolidone, N-vinylcaprolactam, N-vinyllaurolactam, (meth)acryloylmorpholine, (meth)acrylamide, N,N-dimethyl(meth)acrylamide, N-methylol(meth)acrylamide, N-butoxymethyl(meth)acrylamide, N,N-dimethylaminomethyl(meth)acrylate, and 2-(perhydrophthalimide-N-yl)ethyl acrylate can be mentioned.

From the viewpoint that in the case where the below-described crosslinking agent is used together, a crosslinked structure can be formed between the hydroxyl or carboxyl groups and the crosslinking agent, and the storage modulus of the pressure-sensitive adhesive layer can be adjusted, the polar group-containing monomer is preferably a (meth)acrylate having a hydroxyl group or a carboxylic acid having an ethylenically unsaturated group, and more preferably 2-hydroxyethyl (meth)acrylate, 4-hydroxybutyl (meth)acrylate, 6-hydroxyhexyl (meth)acrylate, or acrylic acid.

The content of the polar group-containing monomer in the acrylic-based polymer is preferably within a range of 0.1 to 20 mass %, more preferably within a range of 1 to 13 mass %, and still more preferably within a range of 1.5 to 8 mass %, relative to the total monomer components constituting the acrylic-based polymer.

The weight average molecular weight of the acrylic-based polymer is preferably within a range of 400,000 to 1,400,000, more preferably within a range of 600,000 to 1,200,000, and still more preferably within a range of 650,000 to 1,100,000. Here, the weight average molecular weight is a weight average molecular weight in terms of standard polystyrene measured by gel permeation chromatography (GPC). Specifically, the weight average molecular weight is determined using “SC8020” manufactured by Tosoh Corporation as the GPC measuring apparatus under the following conditions.
Sample concentration: 0.5 mass % (tetrahydrofuran solution)
Sample injection volume: 100 μL
Eluent: Tetrahydrofuran (THF)
Flow rate: 1.0 mL/min
Column temperature (measurement temperature): 40° C.
Column: “TSKgel GMHHR-H” manufactured by Tosoh Corporation
Detector: Differential refraction

The pressure-sensitive adhesive layer may further contain a tackifying resin for the purpose of adjusting its adhesive properties. As tackifying resins, for example, rosin-based, polymerized rosin-based, polymerized rosin ester-based, rosin phenol-based, stabilized rosin ester-based, disproportionated rosin ester-based, hydrogenated rosin ester-based, terpene-based, terpene phenol-based, petroleum resin-based, C₅/C₉ petroleum resin-based, (meth)acrylate-based, and like various tackifying resins can be mentioned. In addition, tackifying resins that are liquid at room temperature, such as process oils, polyester-based tackifying resins, and low-molecular-weight liquid rubbers such as polybutene, can also be used.

In the case where the pressure-sensitive adhesive layer contains a tackifying resin, from the viewpoint that good adhesive properties near room temperature (0 to 40° C.) are achieved, and thermal durability can be exhibited, the amount thereof is preferably within a range of 1 to 150 parts by mass, more preferably 10 to 150 parts by mass, per 100 parts by mass of the base resin constituting the pressure-sensitive adhesive layer, such as an acrylic-based polymer. In addition, in the case where the pressure-sensitive adhesive layer contains a tackifying resin, the total content of the base resin and the tackifying resin in the tackiness agent forming the pressure-sensitive adhesive layer is preferably 50 mass % or more, more preferably 70 mass % or more, and still more preferably 90 mass % or more, relative to the total solids content of the tackiness agent.

The pressure-sensitive adhesive layer may further contain a crosslinking agent for the purpose of improving cohesive strength. As crosslinking agents, for example, isocyanate-based, epoxy-based, aziridine-based, polyvalent metal salt-based, metal chelate-based, keto-hydrazide-based, oxazoline-based, carbodiimide-based, silane-based, glycidyl (alkoxy)epoxysilane-based, and like known crosslinking agents can be mentioned.

Without interfering with the effects of the invention, the pressure-sensitive adhesive layer may further contain other additives as necessary, such as oxidation inhibitors, antioxidants, colorants (e.g., pigments and dyes), thickeners, leveling agents, film-forming aids, infrared absorbers, ultraviolet absorbers, and water repellents.

In one mode, the pressure-sensitive adhesive layer may further contain a thermoplastic resin. According to a preferred mode, from the viewpoint that the melt-softening layer is selectively melted or softened by the heat generated from the heating element in the pressure-sensitive adhesive tape of the invention, such a thermoplastic resin is different from the thermoplastic resin contained in the melt-softening layer and is composed of a component that is less likely to melt or soften upon heating.

More specifically, according to a preferred mode, a thermoplastic resin such that the temperature at which its loss tangent (tan δ) becomes 0.8 or more in the temperature range of 40° C. or more is higher than the melting point of the below-described melt-softening layer, for example, is contained.

From the viewpoint of adhesion retention to the adherend and film uniformity during solution coating, the thickness of the pressure-sensitive adhesive layer is preferably within a range of 10 to 200 μm, and more preferably within a range of 20 to 100 μm. Incidentally, the thickness of the pressure-sensitive adhesive layer is the average value obtained by measuring the thickness at five arbitrary points.

The melting point of the pressure-sensitive adhesive layer is preferably higher than the melting point of the below-described melt-softening layer. Here, “melting point of the pressure-sensitive adhesive layer” means the melting point of a composition composed of an acrylic-based tackiness agent, a urethane-based tackiness agent, a rubber-based tackiness agent, a silicone-based tackiness agent, a vinyl ether-based tackiness agent, or the like constituting the pressure-sensitive adhesive layer, as well as the tackifying resin, crosslinking agent, and other additives contained as necessary, and a thermoplastic resin different from the thermoplastic resin contained in the melt-softening layer, etc. (hereinafter simply referred to as “pressure-sensitive adhesive layer composition”).

The melting point of the pressure-sensitive adhesive layer (pressure-sensitive adhesive layer composition) is preferably 130° C. or more, for example, and more preferably within a range of 130° C. to 200° C. As a result of adjusting the melting point of the pressure-sensitive adhesive layer within the above range and adjusting the melting point of the melt-softening layer within the below-described range, the melting or softening of the melt-softening layer can be caused by the heat generated from the heating element prior to the melting or softening of the pressure-sensitive adhesive layer.

That is, at the time of the thermal dismantling of an article having a configuration in which bonding is achieved via the pressure-sensitive adhesive tape of the invention, the melting or softening of the melt-softening layer can be stably and preferentially caused, allowing for easy dismantling.

Incidentally, “melting point of the pressure-sensitive adhesive layer” is the temperature of the endothermic peak accompanying the melting of the pressure-sensitive adhesive layer (pressure-sensitive adhesive layer composition) measured using differential scanning calorimetry (DSC).

It is preferable that the temperature at which the tan δ of the pressure-sensitive adhesive layer (pressure-sensitive adhesive layer composition) becomes 0.8 or more in the temperature range of 40° C. or more is higher than the temperature at which the tan δ of the melt-softening layer becomes 0.8 or more. It is especially more preferable that the temperature at which the tan δ of the pressure-sensitive adhesive layer (pressure-sensitive adhesive layer composition) becomes 0.8 or more is higher than the temperature at which the tan δ of the melt-softening layer becomes 1 or more.

Specifically, the temperature at which the tan δ of the pressure-sensitive adhesive layer (pressure-sensitive adhesive layer composition) is 0.8 in the temperature range of 40° C. or more is preferably higher than the temperature at which the tan δ of the melt-softening layer is 0.8, more preferably higher than the temperature at which the tan δ is 1, and still more preferably higher than the temperature at which the tan δ is 1.2.

As one favorable mode of the pressure-sensitive adhesive layer (pressure-sensitive adhesive layer composition), the maximum tan δ value in the temperature range of 80° C. to 160° C. is preferably less than 1, more preferably less than 0.8, and still more preferably 0.6 or less. From the viewpoint that the pressure-sensitive adhesive layer can exhibit viscosity and elasticity, the tan δ of the pressure-sensitive adhesive layer (pressure-sensitive adhesive layer composition) in the temperature range of 80° C. to 160° C. is preferably 0.2 or more.

As one favorable mode of the pressure-sensitive adhesive layer, the temperature range in which the tan δ of the pressure-sensitive adhesive layer (pressure-sensitive adhesive layer composition) becomes 0.8 or more is preferably more than 150° C., and more preferably 170° C. or more. The upper limit of the above temperature range is not particularly set, but can be 300° C., for example, preferably 250° C.

In the pressure-sensitive adhesive tape of the invention, if the pressure-sensitive adhesive layer has such physical properties, when the pressure-sensitive adhesive layer and the melt-softening layer receive the same amount of heat from the heating element, the melting and/or softening of the pressure-sensitive adhesive layer can be suppressed. That is, at the time of the thermal dismantling of an article having a configuration in which bonding is achieved via the pressure-sensitive adhesive tape of the invention, the melting or softening of the melt-softening layer can be stably and preferentially caused while suppressing the melting or softening of the pressure-sensitive adhesive layer, allowing for easy dismantling within a short period of time.

Incidentally, from the viewpoint that good adhesive properties to the adherend can be exhibited before and after dismantling, the tan δ of the pressure-sensitive adhesive layer (pressure-sensitive adhesive layer composition) at 23° C. is preferably 0.1 to 0.8, and more preferably 0.2 to 0.6.

The tan δ of the pressure-sensitive adhesive layer (pressure-sensitive adhesive layer composition) is determined by dynamic viscoelasticity measurement at a frequency of 1 Hz. For example, a test piece of the pressure-sensitive adhesive layer composition having a dry thickness of about 2 mm is prepared, and the storage modulus G′ and the loss modulus (G″) are measured using a viscoelasticity tester (ARES-G2 manufactured by TA Instruments Japan) under the conditions of a frequency of 1 Hz, a temperature range of −40° C. to 200° C., and a temperature rise rate of 2° C./min.

Tan δ is determined by the calculation formula [tan δ=G″/G′].

The tan δ of the pressure-sensitive adhesive layer (pressure-sensitive adhesive layer composition) can be adjusted by the kind and combination of monomers constituting the base polymer of the tackiness agent serving as a main component, such as the acrylic-based polymer described above, the incorporation proportion of each monomer, the incorporation amount of the tackifying resin added as necessary, the addition amount of the crosslinking agent added as necessary (gel fraction), and the like.

### [Melt-Softening Layer]

The melt-softening layer constituting the pressure-sensitive adhesive tape of the invention contains a thermoplastic resin.

### <Thermoplastic Resin>

As thermoplastic resins, for example, urethane-based resins, polycarbonates, vinyl chloride-based resins, acrylic-based resins, crystalline or non-crystalline polyester-based resins such as polyethylene terephthalate, polyamide-based resins, styrene-based resins, olefin-based resins, cellulose-based resins, silicone-based resins, fluorine-based resins, styrene-based thermoplastic elastomers, olefin-based thermoplastic elastomers, vinyl chloride-based thermoplastic elastomers, acrylic-based thermoplastic elastomers, urethane-based thermoplastic elastomers, ester-based thermoplastic elastomers, amide-based thermoplastic elastomers, and the like can be mentioned.

A single kind thereof may be used alone, and it is also possible to use two or more kinds together.

Among the thermoplastic resins described above, urethane-based resins, acrylic-based resins, polyester-based resins, styrene-based thermoplastic elastomers, olefin-based thermoplastic elastomers, vinyl chloride-based thermoplastic elastomers, acrylic-based thermoplastic elastomers, urethane-based thermoplastic elastomers, ester-based thermoplastic elastomers, and amide-based thermoplastic elastomers are preferrable, and styrene-based thermoplastic elastomers are more preferrable.

These thermoplastic resins can be melted or softened by the heat generated from the heating element of the pressure-sensitive adhesive tape of the invention, making it possible to melt or soften the melt-softening layer even without the presence of a component that generates the starting point of detachment at the adhesive interface, such as a heat-foaming agent, or a component for causing a decrease in adhesion force.

Therefore, the pressure-sensitive adhesive tape is more likely to become detachable. In addition, the resin preferably has a softening point, and when the temperature becomes higher than the softening point, the melt-softening layer rapidly becomes flexible and exhibits high deformability and fluidity, which is likely to be an advantage.

The styrene-based thermoplastic elastomer is preferably a block copolymer composed of a polymer block containing a structural unit derived from an aromatic vinyl compound and a polymer block containing a structural unit derived from a conjugated diene compound, or a hydrogenated product thereof.

Specifically, a polystyrene-polybutadiene diblock copolymer or a hydrogenated product thereof, a polystyrene-poly(ethylene-butylene) diblock copolymer (SEB); a polystyrene-polybutadiene-polystyrene triblock copolymer (SBS) or a hydrogenated product thereof, a polystyrene-poly(ethylene-butylene)-polystyrene triblock copolymer (SEBS); a polystyrene-polyisoprene diblock copolymer or a hydrogenated product thereof, a polystyrene-poly(ethylene-propylene) diblock copolymer (SEP); a polystyrene-polyisoprene-polystyrene triblock copolymer (SIS) or a hydrogenated product thereof, a polystyrene-poly(ethylene-propylene)-polystyrene triblock copolymer (SEPS); a polystyrene-polybutadiene-polystyrene-polybutadiene tetrablock copolymer (SBSB) or a hydrogenated product thereof; a polystyrene-polybutadiene-polystyrene-polybutadiene-polystyrene pentablock copolymer (SBSBS); styrene-based multiblock copolymers; hydrogenated products obtained by hydrogenating the ethylenic double bond of a styrene-based random copolymer such as styrene-butadiene rubber (SBR); and the like can be mentioned.

In addition, it is also possible to use a commercially available product as a styrene-based thermoplastic elastomer.

The weight average molecular weight of the styrene-based thermoplastic elastomer is preferably within a range of 10,000 to 800,000, more preferably within a range of 30,000 to 500,000, and still more preferably within a range of 50,000 to 300,000.

When the weight average molecular weight is within the above range, the storage modulus and loss tangent of the melt-softening layer can be easily adjusted within the desired range, facilitating the melting or softening of the melt-softening layer upon heating.

Incidentally, the weight average molecular weight of the styrene-based thermoplastic elastomer can be determined in the same manner as in the measurement of the weight average molecular weight of an acrylic-based polymer described above.

A single kind of styrene-based thermoplastic elastomer may be used alone, and it is also possible to use two or more kinds together. That is, the styrene-based thermoplastic elastomer may be one or more kinds of triblock copolymers, one or more kinds of diblock copolymers, or a mixture of a triblock copolymer and a diblock copolymer. Among them, from the viewpoint that the melt-softening layer exhibits appropriate cohesive strength, has good adhesion force near room temperature (0 to 40° C.) before heating, and can easily melt or soften upon heating, it is preferable that the styrene-based thermoplastic elastomer contains at least a diblock copolymer.

The content of the diblock copolymer in the styrene-based thermoplastic elastomer is preferably within a range of 10 to 100 mass %, more preferably within a range of 10 to 90 mass %, still more preferably within a range of 15 to 80 mass %, and, from the viewpoint of achieving an excellent balance between the adhesive properties at 20° C. and the meltability upon heating, particularly preferably within a range of 20 to 75 mass %.

The melt-softening layer is melted or softened by the heat generated from the heating element, and, as a result, the adhesion force during heating decreases to fall below the adhesion force near room temperature (0 to 40° C.).

The content of the thermoplastic resin in the melt-softening layer is preferably within a range of 30 to 95 mass %, more preferably within a range of 35 to 90 mass %, based on the overall amount of the melt-softening layer. When the incorporation amount of the thermoplastic resin in the melt-softening layer is within the above range, this is advantageous from the viewpoint of controlling the coatability and the melt-softening temperature of the melt-softening layer.

### <Optional Components>

The melt-softening layer may further contain a filler for the purposes of imparting flexibility to improve the initial adhesion force and also of reducing the thermal conductivity to enhance the thermal storage effect of the melt-softening layer. Fillers include organic fillers and inorganic fillers, and they may be solid or hollow.

As resins constituting organic fillers, resins containing a structural unit derived from acrylonitrile, vinyl chloride, vinylidene chloride, styrene, vinyl acetate, ethylene, (meth)acrylic acid ester, or the like can be mentioned.

For example, acrylonitrile-based copolymers, vinylidene chloride-based copolymers, acrylic-based copolymers, styrene-based copolymers, polyethylene-based polymers, and the like can be mentioned. The surface of the organic filler may be surface-treated with an organic surface treatment agent, such as a fatty acid or a fatty acid ester, or with an inorganic surface treatment agent, such as calcium carbonate, barium sulfate, talc, titanium oxide, titanium, clay, or silica.

As inorganic substances constituting inorganic fillers, for example, metal oxide-based ceramics such as alumina, silica, silica alumina, zirconia, and magnesia; non-oxide-based ceramics such as silicon carbide, boron carbide, nitrogen carbide, aluminum nitride, silicon nitride, and boron nitride; glass, calcium carbonate, volcanic ash (shirasu), fly ash, and the like can be mentioned.

The inorganic filler may be subjected to a surface treatment such as hydrophobization with a silane coupling agent, a fluorine-based compound, or the like.

A single kind of filler may be used alone, and it is also possible to use two or more kinds together.

In the case where the melt-softening layer further contains a filler, the amount thereof is usually preferably within a range of 5 to 80 vol %, more preferably within a range of 10 to 65 vol %, relative to the total volume of the melt-softening layer. In addition, the content of the organic filler or inorganic filler is usually preferably within a range of 0.01 to 30 mass %, more preferably 0.02 to 20 mass %, relative to the total mass of the melt-softening layer.

Without interfering with the effects of the invention, the melt-softening layer may further contain other additives as necessary, such as oxidation inhibitors, antioxidants, colorants (e.g., pigments and dyes), thickeners, leveling agents, film-forming aids, infrared absorbers, ultraviolet absorbers, and water repellents.

The melt-softening layer may further contain a tackifying resin for the purpose of adjusting its adhesive properties. The details of the tackifying resin are the same as those of the tackifying resin described in the Pressure-Sensitive Adhesive Layer section.

A single kind of tackifying resin may be contained alone, or it is also possible that two or more kinds are contained. In addition, in the case where the melt-softening layer contains a tackifying resin, it is preferable that a tackifying resin having a mass loss rate of 5% or less when the temperature is raised under a condition of 10° C./min from 25° C. to 200° C. in nitrogen is contained.

In the case where the melt-softening layer contains a tackifying resin, from the viewpoint that good adhesive properties near room temperature (0 to 40° C.) are achieved, and thermal durability can be exhibited, the amount thereof is preferably within a range of 1 to 150 parts by mass, more preferably within a range of 10 to 150 parts by mass, per 100 parts by mass of the thermoplastic resin constituting the melt-softening layer.

In addition, in the case where the melt-softening layer contains a tackifying resin, the total content of the thermoplastic resin and the tackifying resin constituting the melt-softening layer is preferably within a range of 70 to 99.9 mass %, more preferably within a range of 80 to 99.8 mass %, relative to the total mass of all components constituting the melt-softening layer, that is, the thermoplastic resin and the tackifying resin, as well as the crosslinking agent, filler, and other additives, etc., contained as necessary.

The melt-softening layer may further contain a crosslinking agent for the purpose of improving cohesive strength. The details of the crosslinking agent are the same as those of the crosslinking agent described in the Pressure-Sensitive Adhesive Layer section.

### <Physical Properties of Melt-Softening Layer>

The melting point of the melt-softening layer is preferably lower than the melting point of the pressure-sensitive adhesive layer, and is specifically preferably within a range of 80 to 200° C., more preferably within a range of 90 to 180° C., and still more preferably within a range of 100 to 160° C.

Here, “melting point of the melt-softening layer” means the melting point of the composition that contains the thermoplastic resin described above and constitutes the melt-softening layer.

As used herein, “composition that contains a thermoplastic resin and constitutes the melt-softening layer” will also be referred to simply as “melt-softening resin composition” hereinafter.

In other words, the melt-softening resin composition is a composition composed of the thermoplastic resin constituting the melt-softening layer, as well as the tackifying resin, crosslinking agent, and other additives, etc., further contained as necessary. “Melting point of the melt-softening layer” means the melting point of such a melt-softening resin composition.

When the melting point of the melt-softening layer is within the above range, the pressure-sensitive adhesive tape of the invention can exhibit high adhesion force before heating. Then, at the time of the thermal dismantling of an article having a configuration in which bonding is achieved via the pressure-sensitive adhesive tape of the invention, even when the amount of heating by the heat generated from the heating element is small, the melting or softening of the melt-softening layer can be stably and preferentially caused, allowing for easy dismantling within a short period of time.

Incidentally, “melting point of the melt-softening layer” is the temperature of the endothermic peak accompanying the melting of the melt-softening resin composition measured using differential scanning calorimetry (DSC).

From the viewpoint of fixing adherends well together in the state near room temperature (0 to 40° C.), the storage modulus G₂₃ at 23° C. of the melt-softening layer (i.e., melt-softening resin composition) described above is preferably 1.0×10³ Pa to 1.0×10⁹ Pa, more preferably 1.0×10³ Pa to 5.0×10⁷ Pa, still more preferably 5.0×10³ Pa to 5.0×10⁷ Pa, yet more preferably 5.0×10³ Pa to 5.0×10⁶ Pa, and particularly preferably 5.0×10³ Pa to 1.0×10⁶ Pa. From the viewpoint of easily separating adherends from each other through heating, the storage modulus G₁₂₀ of the melt-softening layer at 120° C. is preferably 1.0×10⁰ Pa to 5.0×10⁶ Pa, more preferably 1.0×10³ Pa to 1.0×10⁶ Pa, still more preferably 1.0×10³ Pa to 1.0×10⁶ Pa, and yet more preferably 5.0×10³ Pa to 5.0×10⁵ Pa. When the storage modulus G₁₂₀ is within the above range, the melt-softening layer melts or softens within a short period of time upon heating, allowing for detachment.

In addition, the tan δ of the melt-softening layer in the temperature range of 80° C. or more (preferably the tan δ in the temperature range of 100° C. or more) is preferably 0.8 or more, and more preferably 1 or more.

As one favorable mode of the melt-softening layer, the temperature at which the tan δ of the melt-softening layer becomes 0.8 or more is preferably lower than the temperature at which the tan δ of the pressure-sensitive adhesive layer (pressure-sensitive adhesive layer composition) becomes 0.8 or more.

In detail, the temperature range in which the tan δ of the melt-softening layer becomes 0.8 or more is preferably 80° C. or more, for example, more preferably 80° C. or more and 200° C. or less, still more preferably 100° C. or more and 160° C. or less, and yet more preferably 100° C. or more and 130° C. or less.

More specifically, the temperature at which the tan δ of the melt-softening layer is 0.8 is preferably 80° C. or more, more preferably 80° C. or more and 200° C. or less, and still more preferably 100° C. or more and 160° C. or less. In addition, the temperature at which the tan δ of the melt-softening layer is 1 is preferably 80° C. or more, more preferably 80° C. or more and 200° C. or less, and still more preferably 100° C. or more and 180° C. or less.

The difference between the temperature at which the tan δ of the melt-softening layer is 0.8 (more preferably the temperature at which the tan δ is 1) and the temperature at which the tan δ of the pressure-sensitive adhesive layer (pressure-sensitive adhesive layer composition) is 0.8 (more preferably the temperature at which the tan δ is 1) may be a temperature difference that causes the melt-softening layer to preferentially melt or soften upon the reception of heat from the heating element, and is 10° C. or more, for example, preferably 25° C. or more, more preferably 30° C. or more, and still more preferably 50° C. or more.

In the pressure-sensitive adhesive tape of the invention, if the melt-softening layer has such physical properties, when the pressure-sensitive adhesive layer and the melt-softening layer receive the same amount of heat from the heating element, the melting and/or softening of the melt-softening layer is likely to occur preferentially.

When the melt-softening layer reaches the below-described desired dismantling temperature range due to the heat generated from the heating element, because of melting or softening, plastic deformation is likely to occur, and, as a result of cohesive failure in the melt-softening layer, detachment can be caused in the layer of the melt-softening layer or at the interface between the melt-softening layer and the adjacent layer or adherend.

That is, at the time of the thermal dismantling of an article having a configuration in which bonding is achieved via the pressure-sensitive adhesive tape of the invention, the melting or softening of the melt-softening layer can be stably and preferentially caused, allowing for easy dismantling within a short period of time.

Incidentally, from the viewpoint of achieving good adhesive properties before dismantling, the tan δ of the melt-softening layer at 23° C. is preferably 0.1 to 0.8, and more preferably 0.2 to 0.6.

Incidentally, the storage modulus G and the tan δ of the melt-softening layer (i.e., the melt-softening resin composition) are determined by dynamic viscoelasticity measurement. For example, a test piece of the melt-softening resin composition having a dry thickness of about 2 mm is prepared, and, using a viscoelasticity tester (ARES-G2 manufactured by TA Instruments Japan), the storage modulus G′ and the loss modulus (G″) are measured at each temperature under the conditions of a frequency of 1 Hz, a temperature range of −40° C. to 200° C., and a temperature rise rate of 2° C./min. Tan δ is determined by the calculation formula [tan δ=G″/G′].

The storage modulus G₂₃, storage modulus G₁₂₀, tan δ, and melting point of the melt-softening layer can be adjusted by the kind and combination of thermoplastic resins, the incorporation amount of the tackifying resin added as necessary, the addition amount of the crosslinking agent added as necessary, and the like.

From the viewpoint of coatability, adhesion retention to the adherend, and dismantlability, the thickness of the melt-softening layer can be 500 μm or less, and is preferably within a range of 10 to 200 μm, and more preferably within a range of 20 to 150 μm. Incidentally, the thickness of the melt-softening layer is the average value obtained by measuring the thickness at five arbitrary points.

The pressure-sensitive adhesive tape of the invention has at least one melt-softening layer adjacent to the heating element, and it is also possible to have a melt-softening layer c1 adjacent to one surface of a heating element in layer form and a melt-softening layer c2 adjacent to the other surface of the heating element. The specific layer configuration of the pressure-sensitive adhesive tape having two melt-softening layers will be described later.

### [Layer Configuration of Pressure-Sensitive Adhesive Tape]

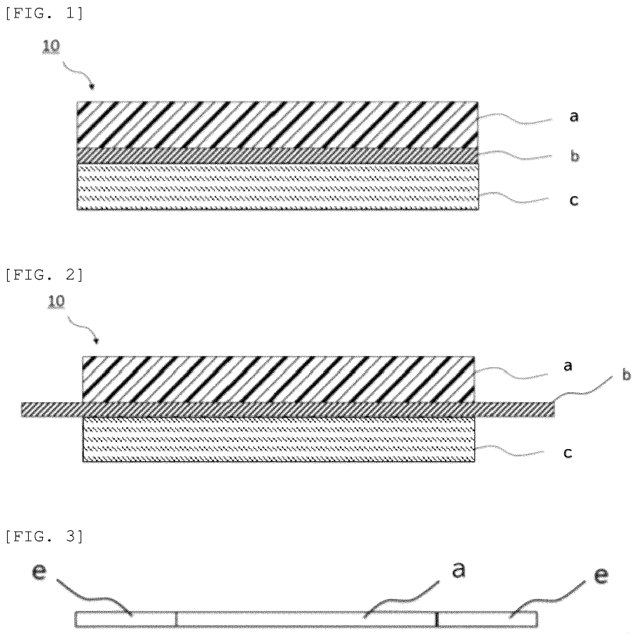

A first mode of the pressure-sensitive adhesive tape of the invention may be, as shown in FIGS. 1 and 2, the mode of a laminate in which the pressure-sensitive adhesive tape 10 has a planar heating element b, a pressure-sensitive adhesive layer a disposed on one surface side of the planar heating element b, and a melt-softening layer c disposed on the other surface side of the planar heating element b, which are laminated in the following order: pressure-sensitive adhesive layer a/heating element b/melt-softening layer c.

Due to the heat generated from the heating element b, the melt-softening layer c adjacent to the heating element b melts or softens, and the adhesion force decreases, allowing for detachment.

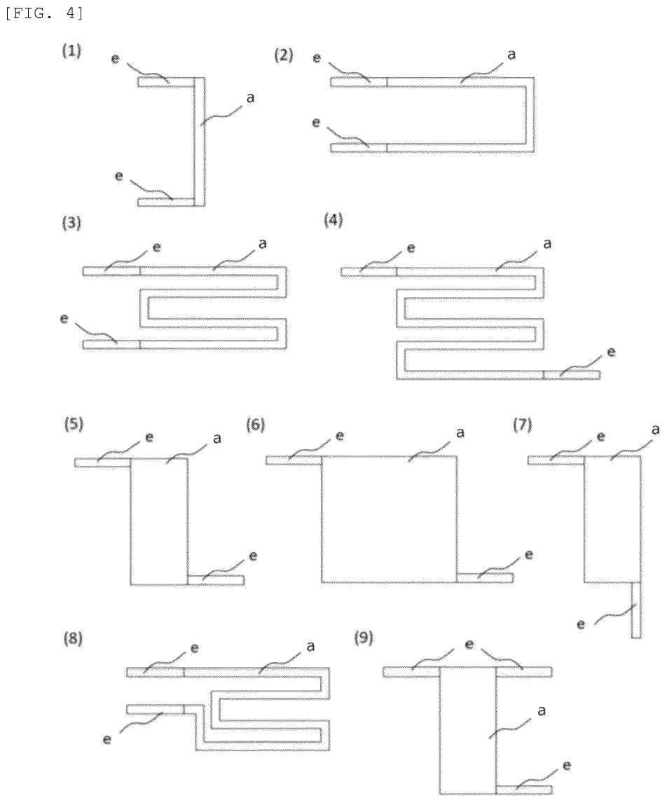

In a plan view of the planar heating element b, the planar heating element b preferably has a pair of projecting portions e projecting and exposed from the outer periphery of the pressure-sensitive adhesive layer a and the melt-softening layer c (see FIGS. 3 and 4). The projecting portions e may be provided in two or more independent locations, and their positions in the heating element are not particularly restricted and can be suitably selected depending on the purpose. The projecting portions e at two locations may be positioned on the same side of the outer periphery of the pressure-sensitive adhesive layer a and the melt-softening layer c (see FIGS. 4(1) to (3)), or may also be positioned on two different sides, respectively (see FIG. 3 and FIGS. 4(4) to (6)).

The projecting portions e are preferably positioned on two opposing sides, respectively, on the outer periphery of the pressure-sensitive adhesive layer a and the melt-softening layer c (see FIGS. 4(4) to (6)), and preferably positioned approximately on the diagonal line on the outer periphery of the pressure-sensitive adhesive layer a and the melt-softening layer c (see FIGS. 4(2) to (7)). In addition, in the case where the projecting portions e are positioned on the same side of the outer periphery of the pressure-sensitive adhesive layer a and the melt-softening layer c, it is preferable that the heating element b has a U-shape or a zigzag shape in a plan view (see FIGS. 4(1) to (4) and (8)), or may also be positioned in close proximity to each other on the same side as long as the heating element b can achieve uniform in-plane heating of the pressure-sensitive adhesive layer a and the melt-softening layer c (see FIGS. 4(3) and (8)).

As a result, the current can flow through the entire area of the planar heating element b, and the heat generation efficiency can be further enhanced.

It is also possible that the projecting portions e are provided at three or more locations (see FIG. 4(9)), and a desired pair (two locations) is suitably selected to pass a current through the heating element. The pair of projecting portions e of the heating element b functions as a pair of terminals for electrical connection to the power supply in the below-described method for dismantling an article, making it possible to easily pass a current through the heating element b.

The length of the projecting portions is preferably 1 to 50 mm, more preferably 2 to 25 mm, in terms of facilitating the contact with the power supply or the heat generation source. Each projecting portion may be bent in a direction different from the plane direction of the pressure-sensitive adhesive tape.

For example, it is possible that when the adherends are in the state of being attached together, the projecting portions are folded in a direction perpendicular to the plane direction of the pressure-sensitive adhesive tape and stored, and when the attachment between the adherends is to be released (at the time of dismantling), the projecting portions are folded again in the plane direction to bring the projecting portions into contact with the power supply or the heat generation source.

As a second mode, as shown in FIG. 5, the pressure-sensitive adhesive tape of the invention may also be in a mode where the pressure-sensitive adhesive tape 20 is a laminate of pressure-sensitive adhesive layer a1/heating element b/melt-softening layer c/pressure-sensitive adhesive layer a2 laminated in this order.

Alternatively, a mode where the pressure-sensitive adhesive tape 20 is a laminate of pressure-sensitive adhesive layer a1/melt-softening layer c1/heating element b/melt-softening layer c2 laminated in this order is also possible, and, in this case, a pressure-sensitive adhesive layer a2 may further be present on the opposite side of the melt-softening layer c2 from the heating element b side.

That is, as the second mode of the pressure-sensitive adhesive tape of the invention, a laminate having a heating element b, a pressure-sensitive adhesive layer a1 disposed on one surface of the heating element b, a melt-softening layer c disposed on the other surface of the heating element b, and a pressure-sensitive adhesive layer a2 on a surface of the melt-softening layer c different from the surface adjacent to the heating element b can be mentioned.

In addition, as another example of the second mode, a laminate having a heating element b, a melt-softening layer c1 and a melt-softening layer c2 disposed on both surfaces, respectively, of the heating element b, a pressure-sensitive adhesive layer a1 disposed on a surface of the melt-softening layer c1 different from the surface adjacent to the heating element b, and a pressure-sensitive adhesive layer a2 disposed on a surface of the melt-softening layer c2 different from the surface adjacent to the heating element b can be mentioned.

Due to the heat generated from the heating element b, the melt-softening layer c1 or c2 adjacent to the heating element b melts or softens, and the adhesion force decreases, allowing for detachment. According to the second mode of the pressure-sensitive adhesive tape of the invention, in which a pressure-sensitive adhesive layer is further provided on a surface of the melt-softening layer different from the surface adjacent to the heating element (opposite surface), the initial adhesion force can be enhanced, and also the reduction rate of adhesion force through heating increases.

The planar heating element b preferably has, in a plan view, a pair of projecting portions projecting and exposed from the outer periphery of the pressure-sensitive adhesive layer a1, the pressure-sensitive adhesive layer a2, and the melt-softening layer c. The details of the projecting portions are the same as the details of the projecting portions of the planar heating element b in the first mode.

The pressure-sensitive adhesive tape of the invention may have a release layer (also referred to as release sheet or release liner). As release layers, for example, glassine paper, kraft paper, clay-coated paper, paper laminated with polyethylene or like films, paper coated with a resin such as polyvinyl alcohol or an acrylic ester copolymer, a polyester, polypropylene, or like synthetic resin film coated with a fluororesin or a silicone resin, and the like can be mentioned. The release layer may be present on one or both surfaces of the pressure-sensitive adhesive tape of the invention.

In addition to the pressure-sensitive adhesive layer, the heating element, and the melt-softening layer, the pressure-sensitive adhesive tape of the invention may also have other layers as long as the outermost layers (excluding the release layer) positioned to face each other in the thickness direction have adhesion surfaces that can be attached to the adherend, examples thereof including functional layers having insulating properties, thermal insulation properties, heat-shielding properties, and like functions, such as insulating layers and thermal insulation layers (e.g., foamed resin layer, hollow-containing layer, hollow particle-containing layer, etc.).

In the pressure-sensitive adhesive tape of the invention, the pressure-sensitive adhesive layer a and the melt-softening layer c in the first mode described above may serve as the adhesion surfaces with the adherend, and it is also possible that the pressure-sensitive adhesive layer a1 and the pressure-sensitive adhesive layer a2 in the second mode described above serve as the adhesion surfaces with the adherend.

The pressure-sensitive adhesive tape of the invention may be configured as in the following examples, but is not limited thereto. In the following laminated configurations, “/” indicates a laminated interface. For example, “layer A/layer B” means that the layer A and the layer B are adjacent to each other, that is, in direct contact with each other. —Release layer/pressure-sensitive adhesive layer a/heating element b/melt-softening layer c, —Pressure-sensitive adhesive layer a/heating element b/melt-softening layer c/release layer, —Release layer/pressure-sensitive adhesive layer a/heating element b/melt-softening layer c/release layer, —Pressure-sensitive adhesive layer a/functional layer/heating element b/melt-softening layer c/release layer, —Release layer/pressure-sensitive adhesive layer a/functional layer/heating element b/melt-softening layer c/release layer, —Release layer/pressure-sensitive adhesive layer a/heating element b/melt-softening layer c/pressure-sensitive adhesive layer a, —Pressure-sensitive adhesive layer a/heating element b/melt-softening layer c/pressure-sensitive adhesive layer a/release layer, —Release layer/pressure-sensitive adhesive layer a/heating element b/melt-softening layer c/pressure-sensitive adhesive layer a/release layer, —Release layer/pressure-sensitive adhesive layer a/heating element b/melt-softening layer c/functional layer/pressure-sensitive adhesive layer a, —Release layer/pressure-sensitive adhesive layer a/functional layer/heating element b/melt-softening layer c/pressure-sensitive adhesive layer a/release layer, —Release layer/pressure-sensitive adhesive layer a/functional layer/heating element b/melt-softening layer c/functional layer/pressure-sensitive adhesive layer a/release layer, —Release layer/pressure-sensitive adhesive layer a/melt-softening layer c/heating element b/melt-softening layer c/release layer

The overall thickness of the pressure-sensitive adhesive tape of the invention is preferably within a range of 50 μm to 2,000 μm, more preferably within a range of 50 μm to 1,000 μm, and still more preferably within a range of 50 μm to 800 μm. In this case, when joining adherends together, cushioning properties (flexibility) and like roles can also be imparted, and also the handling properties of the pressure-sensitive adhesive tape, such as mechanical strength and processability, can be further improved.

### [Application of Pressure-Sensitive Adhesive Tape]

Both surfaces, excluding the release layer, of the pressure-sensitive adhesive tape of the invention function as surfaces having adhesive properties (adhesion surfaces). Therefore, adherends can be attached to both surfaces of the pressure-sensitive adhesive tape, and the tape can be favorably used for joining adherends together.

The pressure-sensitive adhesive tape of the invention becomes detachable upon heating, favorably resistance heating, and thus is particularly favorable for use as a resistance heating (current heating) release tape.

The pressure-sensitive adhesive tape of the invention can be favorably used, for example, for bonding an adherend and an adherend, which are rigid bodies, together, and also for separating an adherend and an adherend from each other.

The pressure-sensitive adhesive tape of the invention becomes easily detachable upon heating, and can therefore be used for applications where the detachment of the pressure-sensitive adhesive tape is required for the separation between components for the purpose of reuse or recycling. For example, the tape can be favorably used as a pressure-sensitive adhesive tape for fixation between components of various products for industrial applications in the industries of electronic devices, automobiles, building materials, office automation, home appliances, and the like, leading to improved operating efficiency at the time of the separation between components, the detachment of labels, and the like.

### [Method for Producing Pressure-Sensitive Adhesive Tape]

The method for producing the pressure-sensitive adhesive tape of the invention is not particularly restricted. For example, the pressure-sensitive adhesive tape of the invention according to the first mode described above can be produced by a method in which a composition containing components for forming the pressure-sensitive adhesive layer and a solvent is applied onto a release sheet and dried to form a pressure-sensitive adhesive layer, a composition containing components for forming the melt-softening layer and a solvent is applied onto another release sheet and dried to form a melt-softening layer, and these layers are sequentially attached to the respective surfaces of a planar heating element.

Here, when the release sheet on the melt-softening layer surface side of the obtained pressure-sensitive adhesive tape is peeled off, and a pressure-sensitive adhesive layer formed as a release sheet is further attached to the exposed surface of the melt-softening layer, the pressure-sensitive adhesive tape of the invention according to the second mode described above can be produced.

Alternatively, when a pressure-sensitive adhesive layer formed as a release sheet is attached to one surface of a planar heating element, and then a composition containing components for forming the melt-softening layer and a solvent is applied to the other surface of the planar heating element and dried to form a melt-softening layer, the pressure-sensitive adhesive tape of the invention according to the first mode described above can be produced.

In addition, when a pressure-sensitive adhesive layer formed as a release sheet is further attached onto the surface of the melt-softening layer of the obtained pressure-sensitive adhesive tape, the pressure-sensitive adhesive tape of the invention according to the second mode described above can be produced.

Further, the composition containing components for forming the pressure-sensitive adhesive layer and the composition containing components for forming the melt-softening layer may also be molded by extrusion molding, press molding, injection molding, or the like.

The solvent is not particularly limited, and, for example, organic solvents such as toluene, xylene, ethyl acetate, butyl acetate, acetone, methyl ethyl ketone, and hexane; water, aqueous solvents composed mainly of water, and the like can be mentioned. Incidentally, the pressure-sensitive adhesive layer and the melt-softening layer of the obtained pressure-sensitive adhesive tape may contain residual solvent, but it is usually preferrable that no solvent is contained.

### 2. Article

The invention is also an article including at least two adherends and the pressure-sensitive adhesive tape of the invention between the two adherends, in which the two adherends are bonded via the pressure-sensitive adhesive tape.

The adherend may have rigidity, or may also have flexibility like a film or the like. The material or shape of the adherend is not particularly restricted, and, for example, plate-shaped adherends, housings, and covers made of resin, glass, or metal, components having any of them on the adherend surface, and the like can be mentioned.

The two adherends bonded via the pressure-sensitive adhesive tape may be the same or different from each other. As the method for bonding adherends, a method in which an adherend is attached to each of the adhesive surfaces of the pressure-sensitive adhesive tape of the invention, thereby attaching the two adherends together, can be mentioned.

The article is not particularly restricted, but is, from the viewpoint that the action and effect produced by the pressure-sensitive adhesive tape of the invention can be effectively utilized, preferably an electronic device, a built-in component in an electronic device, or the like, for example.

In the article of the invention, the heating element constituting the pressure-sensitive adhesive tape preferably has, in a plan view, a pair of projecting portions projecting from the outer periphery of the adherends.

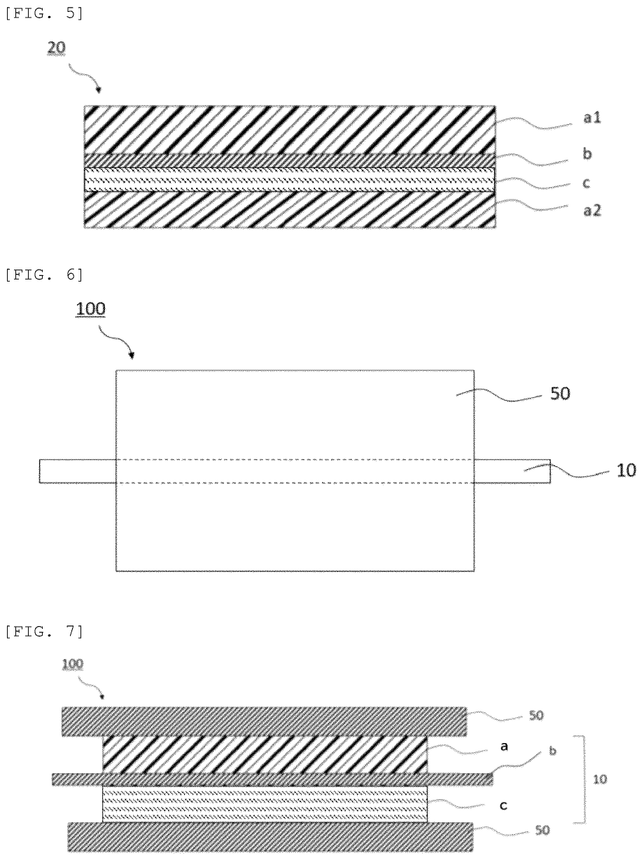

The article 100 of the invention is an article that includes, for example, as shown in the schematic plan view of FIG. 6 and the schematic cross-sectional view of FIG. 7, a pressure-sensitive adhesive tape 10 including two adherends 50 and, between the two adherends 50, a laminate of pressure-sensitive adhesive layer a/planar heating element b/melt-softening layer c laminated in this order, in which the two adherends 50 are bonded via the pressure-sensitive adhesive tape 10.

In a plan view (FIG. 6), both ends in the major axis direction of the planar heating element b project from the outer periphery of the pressure-sensitive adhesive layer a and the melt-softening layer c.

In the case where the heating means in the below-described method for dismantling an article is either resistance heating or thermal conduction, the both projecting ends of the pressure-sensitive adhesive tape 10 can be used as a pair of terminals for electrical connection to the power supply or as end portions for contact with the heat generation source, allowing the heating element b of the pressure-sensitive adhesive tape 10 to be easily heated. In addition, as shown in FIG. 6, in a plan view, a smaller contact area between the adherend and the pressure-sensitive adhesive tape is more advantageous in that the heating efficiency of the heating element is higher, and, at the time of heating, dismantling is more likely to be triggered, making dismantling easier.

In addition, although not shown, the article of the invention may also be an article including two adherends and the pressure-sensitive adhesive tape shown in FIG. 5 between the two adherends, in which the two adherends are bonded via the pressure-sensitive adhesive tape.

In a plan view of the article, the pressure-sensitive adhesive tape may be attached to the entire area of the adherend surface, which is the pressure-sensitive adhesive tape-side surface of the adherend, or it is also possible that the pressure-sensitive adhesive tape is attached to only a portion of the adherend surface of the adherend. As shown in FIG. 6, it is especially preferrable that the pressure-sensitive adhesive tape 10 is attached to a portion of the adherend surface of the adherend 50.

In this case, the plan view shape of the pressure-sensitive adhesive tape 10 in the article may be a band form or a wire form, or may also be a pattern shape. When the contact area between the adherend and the pressure-sensitive adhesive tape is small, this is advantageous from the viewpoint that at the time of the detachment of the pressure-sensitive adhesive tape from the adherend through resistance heating, a starting point for detachment is likely to occur between the adherend and the pressure-sensitive adhesive tape, making detachment easier.

In addition, in a plan view of the article of the invention, in the case where the pressure-sensitive adhesive tape is attached to the entire area of the adherend surface, which is the pressure-sensitive adhesive tape-side surface of the adherend, the plan view shape of the planar heating element in the pressure-sensitive adhesive tape may be the same shape as the plan view shape of the pressure-sensitive adhesive tape, or may also be a band form, a wire form, or a pattern form.

### 3. Method for Dismantling Article

The invention is also a method for dismantling an article, which is a method for dismantling the article of the invention described above, in which the heating element is heated to melt or soften the melt-softening layer, thereby separating the two adherends.

The dismantling method of the invention favorably includes a step of heating the heating element to melt or soften the melt-softening layer, thereby separating at least two adherends (separation step), and may further include other steps as necessary.

The means and method for heating the heating element are not particularly restricted, and, for example, resistance heating, electromagnetic induction heating, infrared heating, microwave heating, thermal conduction, and the like can be mentioned. Among them, resistance heating is preferrable.

In the case where the heating of the heating element is resistance heating, the separation step is preferably a step of electrically connecting the heating element to the power supply, passing a current through the heating element from the power supply, and causing resistance heating to melt or soften the melt-softening layer adjacent to the heating element, thereby separating the two adherends.

The power supply may be an external power supply or the drive power supply of the article, which is an electronic device or a built-in component in an electronic device. In addition, in the case where the article is an electronic device or a built-in component in an electronic device, and the power supply is the drive power supply of the electronic device, the separation step is preferably a step of electrically connecting the heating element to the drive power supply and the electrical circuit of the electronic device, passing a current through the heating element from the drive power supply, and causing resistance heating to melt or soften the melt-softening layer, thereby separating the two adherends.

The method for electrical connection may be such that the heating element or the pair of projecting portions of the heating element projecting from the outer periphery of the pressure-sensitive adhesive layer and the melt-softening layer are electrically connected to the power supply using a known means such as an alligator clip.

The electrical circuit and the electrical connection means are preferably formed from an electrically conductive material exhibiting a volume resistivity different from that of the material of the heating element in the pressure-sensitive adhesive tape, and more preferably formed from an electrically conductive material having a volume resistivity lower than that of the heating element. This is advantageous in that when the heating element is electrically connected to the electrical circuit, and a current is passed through the heating element from the drive power supply, a voltage can be efficiently applied to the heating element while preventing the excessive heating of the electrical circuit and the electrical connection means, allowing for detachment within a short period of time.

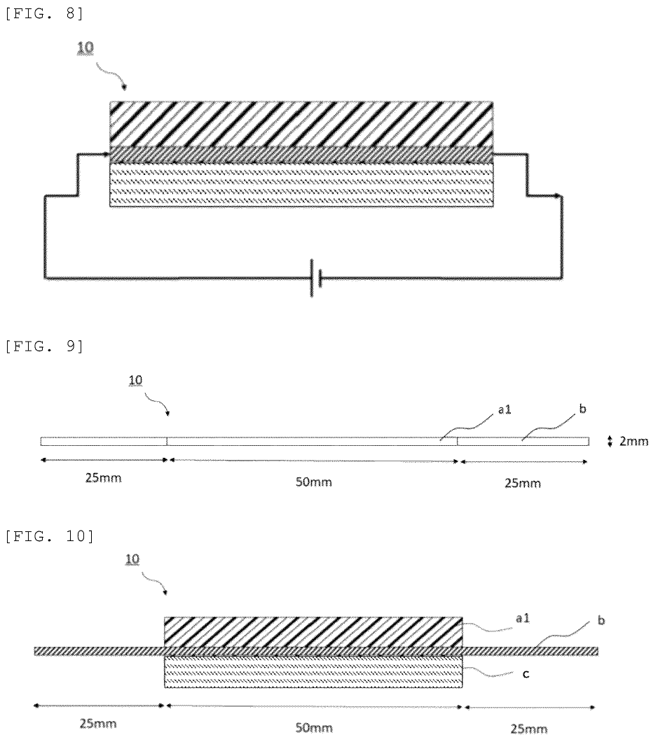

The method for current passage can be suitably selected depending on the size of the pressure-sensitive adhesive tape of the invention, the kind of heating element, and the like, and, for example, a method in which a voltage of 0.1 to 200 V is applied until the melt-softening layer melts or softens (e.g., within a range of 0.5 seconds to 30 minutes) can be mentioned. As schematically shown in FIG. 8, a simple power supply can be used.

As a result of electrically connecting the heating element of the pressure-sensitive adhesive tape of the invention to the power supply, and applying a voltage to the heating element to pass a current therethrough, the heating element and its surroundings are heated by resistance heating. As a result of such heating, the melt-softening layer melts or softens to release the bonded state, and the tape becomes detachable, allowing the attached adherends to be dismantled.

The voltage applied to the heating element due to current passage is usually preferably within a range of 0.1 to 200 V, more preferably 0.5 to 150 V, and still more preferably 1.0 V to 100 V.

In the pressure-sensitive adhesive tape of the invention, the melting or softening of the melt-softening layer occurs within a short period of time even when the applied voltage is low. Accordingly, by applying a voltage within the above range in the separation step, the article can be dismantled within a short period of time without applying an excessive voltage, and thermal damage to the article can be prevented. In particular, by applying a voltage that small electronic devices, household electrical appliances, and like articles can handle, these articles can be easily dismantled.

The current applied to the heating element is not particularly limited, and is usually preferably within a range of 0.01 to 20 A, more preferably 0.03 to 15 A, still more preferably 0.05 to 10 A, and particularly preferably 0.1 to 5 A. In the pressure-sensitive adhesive tape of the invention, because the melting or softening of the melt-softening layer occurs within a short period of time, when the current applied in the separation step is within the above range, a current that flows through general-purpose electronic devices or home appliances can be applied to dismantle the article within a short period of time, and thermal damage to the article can be prevented. In particular, by applying a current that small electronic devices and household electrical appliances can handle, these articles can be easily dismantled.

In addition, the pressure-sensitive adhesive tape of the invention can offer a sufficient amount of heat generation with a low current that does not physically affect the worker even in the case where the worker accidentally comes into contact with live parts during the dismantling operations. Therefore, the dismantling method of the invention is excellent in work safety.

The application time is not particularly restricted, and is usually preferably 0.5 seconds to 30 minutes, more preferably 0.5 seconds to 120 seconds, and still more preferably 0.5 seconds to 30 seconds. When the application time is within the above range, articles can be easily dismantled within a short period of time without causing thermal damage thereto.

In the case where the heating of the heating element is electromagnetic induction heating, the separation step is preferably a step in which the melt-softening layer is melted or softened by electromagnetic induction heating using an electromagnetic induction heating means, thereby separating the two adherends. The electromagnetic induction heating means is not particularly restricted, and a known electromagnetic induction heating apparatus can be suitably selected.

In the case where the heating of the heating element is either infrared heating or microwave heating, the separation step is preferably a step in which the melt-softening layer is melted or softened by either infrared heating using an infrared heating means or microwave heating using a microwave heating means, thereby separating the two adherends.

The infrared heating means and microwave heating means are not particularly restricted, and a known infrared heating apparatus or microwave heating apparatus can be suitably selected.

In the case where the heating of the heating element is thermal conduction, the separation step is preferably a step in which the heating element is brought into contact with a heat generation source, and the melt-softening layer is melted or softened by thermal conduction, thereby separating the two adherends. The heat generation source is not particularly restricted, and a known heater can be suitably selected.

The method for thermal conduction using a heat generation source can be suitably selected depending on the size of the pressure-sensitive adhesive tape, the kind of heating element, and the like, and, for example, a method in which a contact is made at a desired temperature until the melt-softening layer melts or softens can be mentioned.

The temperature for dismantling an article is preferably within a range of 80° C. to 160° C., more preferably within a range of 90° C. to 150° C., and still more preferably within a range of 100° C. to 130° C. When the dismantling temperature is within the above range, thermal damage to the article and the adherends can be suppressed, and dismantling can be easily achieved. Particularly in the case where the pressure-sensitive adhesive tape is heated by resistance heating (current heating), as a result of the direct heat generation inside the tape, dismantling can be achieved before heat is transferred to the article and the adherends.

The temperature for dismantling an article can be measured as the temperature of the heating element that the pressure-sensitive adhesive tape of the invention has (the temperature reached by the heating element during dismantling) with a temperature sensor using a thermocouple.

Embodiments of the pressure-sensitive adhesive tape, article, and method for dismantling an article of the invention have been described above, but the invention is not limited to the configurations of the above embodiments. For example, in the pressure-sensitive adhesive tape of the invention, the configurations of the above embodiments may have added thereto any other configurations, or may also be substituted with any configuration that produces the same effect.

### EXAMPLES

Hereinafter, the invention will be described in detail with reference to examples. However, the invention is not limited to the following examples. The materials used in the examples will be shown below.

### <Heating Element>

### Heating Element 1: Metal Fiber Sheet

A metal fiber (stainless steel fiber) sheet obtained by mixing fibers made of stainless steel having an average fiber diameter of 1 μm to 50 μm and an average fiber length of 100 μm to 20 mm with a binder (organic flocculant) to a basis weight of 50 g/m², and then forming the mixture into a sheet using a papermaking apparatus, followed by sintering. Thickness: 50 μm, volume resistivity at 20° C.: 1,600 μΩ·cm

### Heating Element 2: Graphite Sheet

A graphite sheet obtained by forming carbon fibers (average fiber length: 100 μm to 20 mm) or graphite (average particle size: 1 μm to 100 μm) into a sheet using a papermaking apparatus, followed by sintering. Thickness: 50 μm, volume resistivity at 20° C.: 5,000 μΩ·cm

### Heating Element 3: Cured Phenol Resin-Impregnated Graphite Sheet

A graphite sheet obtained by forming carbon fibers (average fiber length: 100 μm to 20 mm) or graphite (average particle size: 1 μm to 100 μm) into a sheet using a papermaking apparatus, and then impregnating the sheet with a curable phenol resin, followed by sintering using a hot press. Thickness: 90 μm, volume resistivity at 20° C.: 13,700 μΩ·cm

### Heating Element 4: Nichrome Foil

“Nichrome NCH1-H” [trade name, manufactured by Takeuchi Metal Foil & Powder Co., Ltd., thickness: 10 μm. Volume resistivity at 20° C.: 108 μΩ·cm (catalog value), 105 μΩ·cm (measured value)]

### <Release Layer>

Release liner: 75-μm-Thick polyethylene terephthalate, release-treated on one surface side

### Constituent Materials of Melt-Softening Layer (Melt-Softening Resin Composition)

### Preparation Example 1

100 parts by mass of a styrene-isoprene block copolymer composition (mixture of a styrene-isoprene diblock copolymer and a styrene-isoprene triblock copolymer; styrene-derived structural unit: 24 mass %), 40 parts by mass of Quintone G115 (C5/C9 petroleum resin manufactured by Zeon Corporation, softening point: 115° C.), 30 parts by mass of PENSEL D-160 (polymerized rosin ester resin manufactured by Arakawa Chemical Industries, Ltd., softening point: 15° C. to 150° C.), 5 parts by mass of NISSEKI POLYBUTENE HV-50 (polybutene manufactured by JX Nippon Oil & Energy Corporation, pour point: −12.5° C.), and 1 part by mass of an antioxidant (tetrakis[methylene-3-(3′5′-di-t-butyl-4-hydroxyphenyl) propionate]methane) were mixed, and dissolved in 100 parts by mass of toluene as a solvent, thereby giving a resin composition 1.

The obtained resin composition 1 was applied to the release-treated surface of a release liner to a thickness of about 2 mm after drying to prepare a layer 1. Using a viscoelasticity tester (ARES-G2 manufactured by TA Instruments Japan), the storage modulus G′ and the loss modulus (G″) were measured under the conditions of a frequency of 1 Hz, a temperature range of −40° C. to 200° C., and a temperature rise rate of 2° C./min. In addition, the tan δ of the resin composition 1 at a frequency of 1 Hz was determined by the calculation formula [tan δ=G″/G′].

The melting point of the resin composition 1 was 140° C., the storage modulus G₂₃ at 23° C. was 2.5×10⁵ Pa, the storage modulus G₁₂₀ at 120° C. was 5.0×10⁴ Pa, and the temperature at which the tan δ was 0.8 was 125° C. (the temperature range in which the tan δ was 0.8 or more was 125° C. or more).

### Constituent Materials of Pressure-Sensitive Adhesive Layer

### Preparation Example 2

In a reaction vessel equipped with a stirrer, a reflux condenser, a nitrogen inlet tube, and a thermometer, 79.9 parts by mass of n-butyl acrylate, 6 parts by mass of 2-ethylhexyl acrylate, 10 parts by mass of cyclohexyl acrylate, 4 parts by mass of acrylic acid, 0.1 parts by mass of 4-hydroxybutyl acrylate, and 200 parts by mass of ethyl acetate were charged and subjected to nitrogen bubbling at 23° C. for 1 hour with stirring to obtain a mixture. Next, 2 parts by mass of a solution of 2,2′-azobis(2-methylbutyronitrile) previously dissolved in ethyl acetate (solids content: 1.0 mass %) was added to the mixture, and, with stirring, the mixture was stirred at 72° C. for 4 hours and then stirred at 75° C. for 5 hours. Next, the obtained mixture was diluted with ethyl acetate and filtered through a 200-mesh wire mesh to obtain an acrylic copolymer solution (solids concentration: 26%) having a weight average molecular weight of 1,060,000, in which the average number of carbon atoms in the saturated hydrocarbon groups of the alkyl acrylate monomer was 4.4.

To 100 parts by mass of the obtained acrylic copolymer solution, as a crosslinking agent, 1.0 part by mass of an adduct of tolylene diisocyanate and trimethylolpropane (“BURNOCK D-40” manufactured by DIC Corporation, isocyanate-based crosslinking agent, solids content: 40%, hereinafter referred to as “D-40”) was incorporated to obtain a composition (2).

The obtained composition (2) was applied to the release-treated surface of a release liner to a thickness of about 2 mm after drying to prepare a layer (2). Using a viscoelasticity tester (ARES-G2 manufactured by TA Instruments Japan), the storage modulus G′ and the loss modulus (G″) were measured under the conditions of a frequency of 1 Hz, a temperature range of −40° C. to 200° C., and a temperature rise rate of 2° C./min. In addition, the tan δ of the composition (2) at a frequency of 1 Hz was determined by the calculation formula [tan δ=G″/G′]. The melting point of the composition (2) was 150° C. or more, the storage modulus G₂₃ at 23° C. was 7.5×10⁴ Pa, the storage modulus G₁₂₀ at 120° C. was 5.5×10⁴ Pa, and the temperature at which the tan δ was 0.8 was a temperature higher than 150° C. (the temperature range in which the tan δ was 0.8 or more was more than 150° C.). In addition, the maximum tan δ value in the temperature range of 100° C. to 150° C. was 0.4.

### 1. Pressure-Sensitive Adhesive Tape and Article Preparation Examples

### Example 1

### <Preparation of Pressure-Sensitive Adhesive Tape>

The resin composition 1 was applied to the release-treated surface of a release liner to a thickness of 80 μm after drying, and dried at 90° C. for 5 minutes to obtain a melt-softening layer c1 (thermal conductivity: 0.16 W/m-K). Meanwhile, the composition 2 was applied to the release-treated surface of another release liner to a thickness of 50 μm after drying, and dried at 90° C. for 3 minutes to prepare a pressure-sensitive adhesive layer (thermal conductivity: 0.20 W/m-K).

Incidentally, the thermal conductivity of the melt-softening layer and that of the pressure-sensitive adhesive layer are values measured using a quick thermal conductivity meter (“QTM-710” manufactured by Kyoto Electronics Manufacturing Co., Ltd.).

The melt-softening layer c1 cut to an arbitrary width with a length of 50 mm and the heating element 1 with a length of 100 mm were attached together with a hand roller, and positioned such that the heating element 1 projected 25 mm from each end in the longitudinal direction. Similarly, a pressure-sensitive adhesive layer cut to an arbitrary width with a length of 50 mm was attached to the opposite surface of the heating element 1 attached to the melt-softening layer c1. They were laminated with a roll at a linear pressure of 5 kg/cm from the top surface of the release liner, and the laminate was aged in an environment of 40° C. for 48 hours, thereby preparing a laminate shaped such that each end of the heating element 1 projected 25 mm in the longitudinal direction of the heating element 1 from the outer periphery of the melt-softening layer c1 and the pressure-sensitive adhesive layer, in which the total thickness excluding the release liner was 180 μm, and the layer configuration excluding the release liner was pressure-sensitive adhesive layer a1/heating element 1/melt-softening layer c1 laminated in this order. The obtained laminate was cut to a width of 2 mm to obtain a pressure-sensitive adhesive tape (T-1), in which the melt-softening layer c1 and the pressure-sensitive adhesive layer a1 had a size of 2 mm wide×50 mm long, and the heating element 1 had a size of 2 mm×100 mm long, and which had a pair of projecting portions formed of the heating element 1 projecting from the outer periphery of the melt-softening layer c1 and the pressure-sensitive adhesive layer a1. A schematic plan view of the pressure-sensitive adhesive tape (T-1) is shown in FIG. 9, and a schematic cross-sectional view is shown in FIG. 10.

### <Preparation of Article>

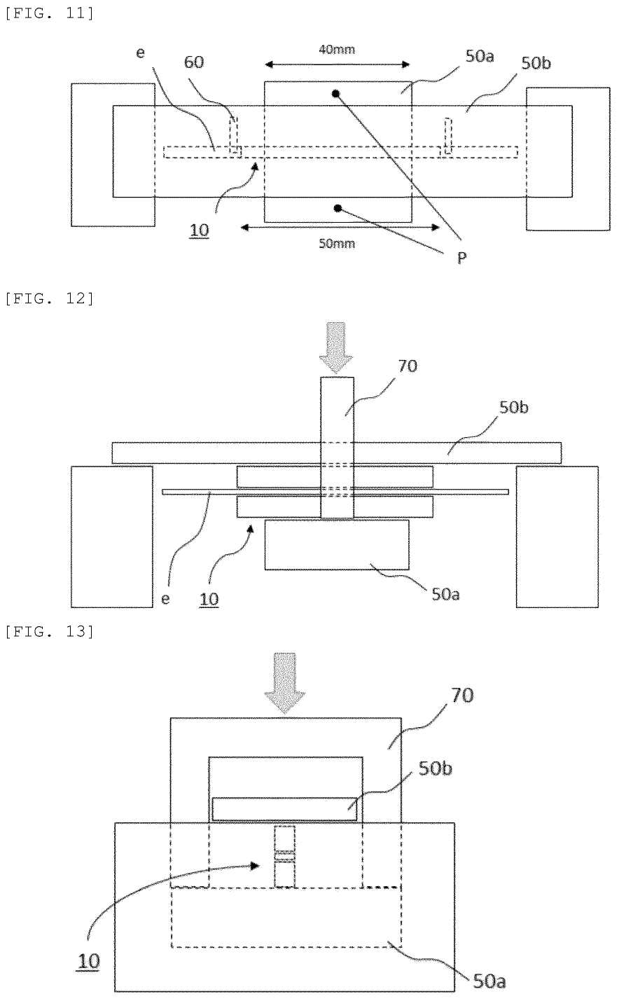

From the pressure-sensitive adhesive tape of Example 1 (indicated by reference numeral 10 in FIGS. 11 to 13), the release liner on the melt-softening layer c1 side was detached, and the tape was attached to an adherend 50a (glass, 40 mm wide×50 mm long×10 mm thick) such that a length of 50 mm of the tape adhesion surface (effective portion) crossed the center of the adherend 50a along the width direction of the adherend 50a (see FIGS. 11 to 13). Next, the release liner on the pressure-sensitive adhesive layer a1 side was detached, and the tape was attached to an adherend 50b (glass, 30 mm wide×100 mm long×2.8 mm thick) forming a shape such that the pressure-sensitive adhesive tape 10 was sandwiched between the adherends (see FIGS. 11 to 13), followed by pressure-bonding at 20 N/cm² for 10 seconds. The obtained attached items were left in an atmosphere of 23° C. and 50% RH for 24 hours or more, thereby giving an article of Example 1.

### Example 2

A pressure-sensitive adhesive tape (T-2) and an article of Example 2 were prepared in the same manner as in Example 1, except that a heating element 2 was used in place of the heating element 1 in Example 1.

### Example 3

A pressure-sensitive adhesive tape (T-3) and an article of Example 3 were prepared in the same manner as in Example 1, except that a heating element 3 was used in place of the heating element 1 in Example 1.

### Reference Example 1

A pressure-sensitive adhesive tape (RT) and a reference example article were prepared in the same manner as in Example 1, except that a heating element 4 was used in place of the heating element 1 in Example 1.

### 2. Evaluation

The articles obtained in the examples and reference example were measured for push strength using the apparatus shown in FIGS. 11 to 13 as follows.

### (1) Push Strength Before Heating

Using the articles obtained in the examples and reference example as test pieces, in an environment of 23° C., the glass plate was pressed at the press position shown in FIG. 11 with the probe 70 shown in FIGS. 12 and 13 in the direction of the arrow at a speed of 10 mm/min, and the strength at which the pressure-sensitive adhesive tape was peeled off [push strength (G1)] was measured.

(2) Push Strength after 10 Seconds of Heating

Using the articles obtained in the examples and reference example as test pieces, the projecting portions e of the heating element in the pressure-sensitive adhesive tape 10 of each test piece were held with an alligator clip 60, and a current of 0.3 A was allowed to flow using a DC stabilized power supply (trade name “PAS160-1” manufactured by Kikusui Electronics Corp.). After 10 seconds from the start of current passage, while continuing the current passage, the glass plate was pressed with the probe 70 shown in FIGS. 12 and 13 in the direction of the arrow at a speed of 10 mm/min, and the strength at which the pressure-sensitive adhesive tape was peeled off [push strength (G2)] was measured. Incidentally, the temperature achieved by the heating element during 0.3-A current heating dismantling (dismantling temperature of the article) was about 95° C. The temperature of the heating element after current passage was measured with a temperature sensor using a thermocouple.

### (3) Residual Adhesion Force

Using the push strength (G1) and the push strength (G2), the residual adhesion force was calculated using the following formula, and the dismantlability was evaluated according to the following criteria.

$$Residual adhesion force ( \% ) = 100 \times G 2 / G 1$$

### [Dismantlability Evaluation Criteria]

A: Residual adhesion force is less than 75%
B: Residual adhesion force is 75% or more and less than 90%
C: Residual adhesion force is 90% or more

The above results are summarized in Table 1.

TABLE 1

| | Reference | | | |
|---|---|---|---|---|
| | Example | Example 1 | Example 2 | Example 3 |
| Heating element | Heating | Heating | Heating | Heating |
| | element 4 | element 1 | element 2 | element 3 |
| Temperature after 0.3-A | 40 | 95 | 120 | 200 |
| 30-min Current Passage (° C.) | | | | |
| Initial State (before | | | | |
| Current Heating) | | | | |
| Push Strength (N/0.8 cm²) | 65 | 60 | 17 | 50 |
| 0.3-A Current Heating | | | | |
| Push Strength (N/0.8 cm²) | 65 | 43 | 13 | 23 |
| Residual Adhesion Force (%) | 99.3 | 71.7 | 78.2 | 45.0 |
| Dismantlability | C | A | B | A |

The pressure-sensitive adhesive tapes of the examples have smaller residual adhesion force [%] after 0.3-A current heating than the pressure-sensitive adhesive tape of the reference example. That is, in the articles made using the pressure-sensitive adhesive tapes of the examples, even in the case where a low current to the extent that does not physically affect the worker is applied, the reduction rate of adhesion force relative to the initial adhesion force is high, indicating excellent dismantlability.

### INDUSTRIAL APPLICABILITY

The pressure-sensitive adhesive tape of the invention can be thermally detached within a short period of time and can prevent thermal damage to the adherend, and allows for easy thermal detachment procedures. Therefore, the pressure-sensitive adhesive tape of the invention can be favorably used for applications where the detachment of the pressure-sensitive adhesive tape is required for the separation between components for the purpose of reuse or recycling, for example, as a pressure-sensitive adhesive tape for fixation between components of various products for industrial applications in the industries of electronic devices, automobiles, building materials, office automation, home appliances, and the like, leading to improved operating efficiency at the time of the separation between components, the detachment of labels, and the like.

### REFERENCE SIGNS LIST

a, a1, a2: Pressure-sensitive adhesive layer
b: Heating element
c: Melt-softening layer
e: Projecting portion (of heating element)
10, 20, 30: Pressure-sensitive adhesive tape
50, 50a, 50b: Adherend
100: Article
60: Alligator clip
70: Probe
P: Press position

1. A pressure-sensitive adhesive tape comprising a pressure-sensitive adhesive layer, a heating element, and a melt-softening layer that is adjacent to the heating element at least in this order, wherein the heating element has an average thickness of 2 μm or more and 200 μm or less and is a heating element formed of an electrically conductive filler bound into a sheet.

2. The pressure-sensitive adhesive tape according to claim 1, wherein the heating element has a volume resistivity at 20° C. of 50 μΩ·cm or more.

3. The pressure-sensitive adhesive tape according to claim 1, wherein the heating element is a heating element formed of a fibrous or particulate electrically conductive filler bound into a sheet and further impregnated with a binder.

4. The pressure-sensitive adhesive tape according to claim 1, wherein the heating element is a heating element formed of a fibrous or particulate electrically conductive filler and an organic substance filler bound into a sheet.

5. The pressure-sensitive adhesive tape according to claim 1, wherein the heating element is a heating element formed of a fibrous or particulate electrically conductive filler sintered into a sheet.

6. The pressure-sensitive adhesive tape according to claim 1, wherein the electrically conductive filler is selected from the group consisting of a metal, an alloy, and carbon.

7. The pressure-sensitive adhesive tape according to claim 1, wherein the heating element has, in a plan view, a pair of projecting portions projecting from the outer periphery of the pressure-sensitive adhesive layer and the melt-softening layer.

8. The pressure-sensitive adhesive tape according to claim 1, further comprising a pressure-sensitive adhesive layer on the other surface side of the melt-softening layer from the surface adjacent to the heating element.

9. The pressure-sensitive adhesive tape according to claim 1, wherein the melt-softening layer becomes detachable upon heating.

10. The pressure-sensitive adhesive tape according to claim 1, wherein the heating element is a current-carrying body that generates heat upon the passage of a current, and the heat generation of the current-carrying body causes detachment.

11. An article comprising:
at least two adherends; and
the pressure-sensitive adhesive tape according to claim 1 between the two adherends,
wherein the two adherends are bonded via the pressure-sensitive adhesive tape.

12. The article according to claim 11, wherein the heating element constituting the pressure-sensitive adhesive tape has, in a plan view, a pair of projecting portions projecting from the outer periphery of the adherends.

13. A method for dismantling an article, being a method for dismantling the article according to claim 11,
the method comprising heating the heating element to melt and/or soften the melt-softening layer, thereby separating the two adherends.

14. The method for dismantling an article according to claim 13, wherein the heating of the heating element is resistance heating, and the method includes electrically connecting the heating element to a power supply, passing a current through the heating element from the power supply, and causing resistance heating to melt and/or soften the melt-softening layer, thereby separating the two adherends.
